(19) United States
(12) Patent Application Publication
(10) Pub. No.: US 2014/0012868 A1
(43) Pub. Date: Jan. 9, 2014

(54) COMPUTER PRODUCT AND WORK SUPPORT APPARATUS

(71) Applicant: FUJITSU LIMITED, Kawasaki-shi (JP)

(72) Inventor: Hirofumi NAKAZAKI, Sakura (JP)

(73) Assignee: FUJITSU LIMITED, Kawasaki-shi (JP)

(21) Appl. No.: 14/024,479

(22) Filed: Sep. 11, 2013

Related U.S. Application Data
(63) Continuation of application No. PCT/JP2011/056114, filed on Mar. 15, 2011.

(51) Int. Cl. G06F 17/30

(52) U.S. Cl. CPC G06F 17/30277
USPC 707/758

(57) ABSTRACT

A work support method is executed by a computer. The work support method includes acquiring an image of a field, where position information of a mobile terminal when the mobile terminal recorded the image is appended to the image; searching among a group of fields and based on position information of each field of the group of fields, for a field that is within a given range of a position indicated by the position information appended to the image; and correlating with the image and outputting, annunciation information indicating that multiple fields related to the image are present, when multiple fields are retrieved.

### CROSS REFERENCE TO RELATED APPLICATIONS

This application is a continuation application of International Application PCT/JP2011/056114, filed on Mar. 15, 2011 and designating the U.S., the entire contents of which are incorporated herein by reference.

### FIELD

The embodiments discussed herein are related to a computer product and work support apparatus.

### BACKGROUND

Conventionally, information is shared among persons engaged in agriculture. For example, by sharing pictures of a field taken on site, the state of the field, the state of crop growth as well as the occurrence of disease and pests can be confirmed by multiple users. In this case, to facilitate identification of the field in the picture, a linking of the field and the picture is performed manually.

Related technology includes a technique of acquiring and displaying in a map display section on a screen, map data that includes the photographic point of a user selected image, and based on the map data within the range of the map data display section, editing photographic point information of the user selected image. A further technique involves referring to a farm work log database, and identifying the worker and field from the position information of a terminal carried by the worker to thereby narrow down the work items to be performed by the worker.

For examples such technologies, refer to Japanese Laid-Open Patent Publication Nos. 2010-85445 and 2005-124538.

However, with the conventional technologies, a problem arises in that the identification of a field from the contents of the picture may be difficult, and the time consumed for linking a picture and a field can become enormous. For example, in a picture of crops and/or pests and disease, often only a limited portion of the field is pictured, making identification of the field from the contents of the picture difficult.

### SUMMARY

According to an aspect of an embodiment, a work support method is executed by a computer. The work support method includes acquiring an image of a field, where position information of a mobile terminal when the mobile terminal recorded the image is appended to the image; searching among a group of fields and based on position information of each field of the group of fields, for a field that is within a given range of a position indicated by the position information appended to the image; and correlating with the image and outputting, annunciation information indicating that multiple fields related to the image are present, when multiple fields are retrieved.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a work support apparatus 101 according to a first embodiment;

FIG. 2 is a diagram depicting a system configuration example of a work support system 200 according to a second embodiment;

FIG. 3 is a block diagram of an example of a hardware configuration of the work support apparatus 101 according to the second embodiment;

FIG. 4 is a diagram depicting an example of the contents of a field DB 110;

FIG. 5 is a diagram depicting an example of field position data;

FIG. 6 is a diagram depicting an example of work log data;

FIG. 7 is a diagram depicting an example of material log data

FIG. 8 is a diagram depicting an example of an image DB 210;

FIG. 9 is block diagram of a functional configuration of the work support apparatus 101 according to the second embodiment;

FIG. 10 is a diagram depicting an example of the data of an image;

FIGS. 11A, 11B, and 11C are diagrams depicting an example of the contents of an intermediate table;

FIG. 12 is a diagram depicting an example of searching for a field;

FIG. 13 is a diagram depicting an example of a display data template;

FIG. 14 is a diagram depicting an example of a template for a field changing screen;

FIG. 15 is a diagram depicting an example of the contents of a screen data DB 1500;

FIG. 16 is a flowchart of an example of a procedure of a work support process by the work support apparatus 101 according to the second embodiment;

FIGS. 17 and 18 are flowcharts of a procedure of a candidate field search process at step S1607;

FIG. 19 is a flowchart of an example of a procedure of a screen generating process at step S1610;

FIG. 20 is a diagram depicting an example of a field rounds result list screen;

FIG. 21 is a diagram depicting an example of a field changing screen (part 1);

FIG. 22 is a diagram depicting another example of the field rounds result list screen;

FIG. 23 is a diagram depicting a functional configuration of a generating unit 904 of the work support apparatus 101 according to a third embodiment;

FIG. 24 is a diagram depicting an example of hierarchy information;

FIG. 25 is a flowchart of a procedure of a display attribute determination process by the work support apparatus 101 according to the third embodiment; and

FIG. 26 is a diagram depicting an example of the field changing screen (part 2).

### DESCRIPTION OF EMBODIMENTS

Embodiments of a work support program and work support apparatus will be described in detail with reference to the accompanying drawings. The embodiments can be combined to an extent that contradictions do not arise.

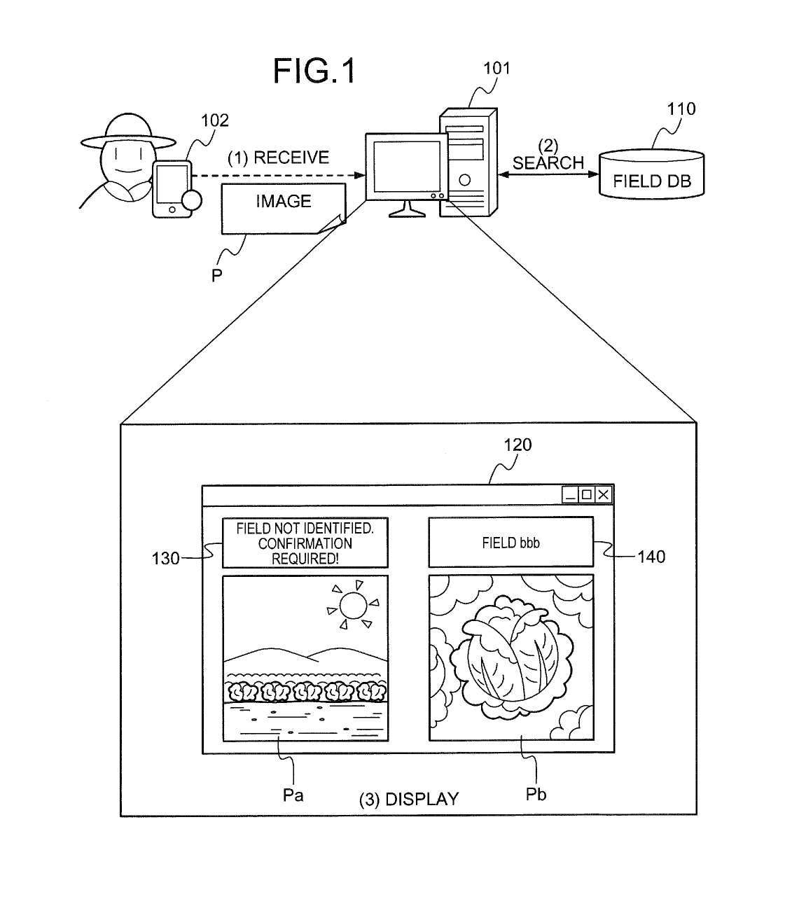

FIG. 1 is a diagram depicting an example of a work support apparatus 101 according to a first embodiment. In FIG. 1, the work support apparatus 101 includes a field (database) DB 110 and is a computer that supports the editing of data by a user engaged in agriculture.

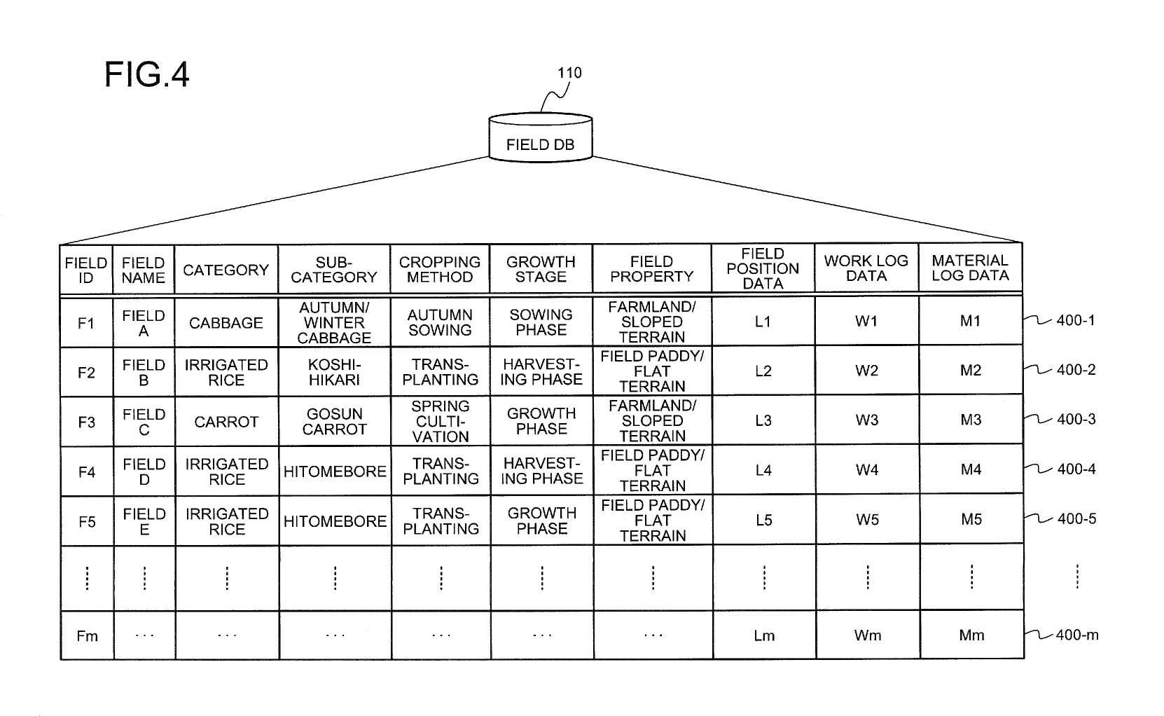

The field DB 110 is a database that stores position information for each field among a group of fields dispersed among various areas. A field is farmland for cultivating and raising crops. Crops are, for example, agricultural products such as grains, vegetables, and fruits grown on farms, etc. The contents of the field DB 110 will be described hereinafter with reference to FIG. 4.

Editing is the editing of data related to farm work. Farm work is work related to cultivating and raising crops, and includes, for example, making field rounds, sowing seeds, plowing, applying fertilizer, preparing soil, weeding, thinning, re-applying fertilizer, ridging, harvesting, etc. Editing, for example, is performed by the user after a day's work, and involves correlating and recording into a log, fields and images thereof recorded during the day.

A mobile terminal 102 is a computer that is used by the user engaged in farm work. For example, the mobile terminal 102 is a mobile telephone, a personal digital assistant (PDA), and the like. The mobile terminal 102 has a function of capturing still and moving images. Further, the mobile terminal 102 has a function of acquiring position information that indicates the position of the mobile terminal 102.

For example, the mobile terminal 102 acquires position information using a global positioning system (GPS) equipped on the mobile terminal 102. The mobile terminal 102 may correct the position information acquired by the GPS by a differential GPS (DGPS). The mobile terminal 102 has a further function of communicating with the work support apparatus 101. The communication may be, for example, wired or wireless communication.

Hereinafter, an example of a procedure of the work support process by the work support apparatus 101 according to the first embodiment will be described.

(1) The work support apparatus 101 receives an image P of a field, recorded by the mobile terminal 102. Position information that concerns the position of the mobile terminal 102 when the image P was recorded by the mobile terminal 102 is appended to the image P. The image P, for example, is recorded by the user to report the progress of farm work, and/or the growth of crops in a field.

(2) The work support apparatus 101 refers to the field DB 110 and from among a group of fields dispersed over various areas, searches for a field that is within a given range of the position indicated by the position information that is for the mobile terminal 102 and is appended to the received image P. Here, when the user records an image of the field, in addition to cases where the user enters the field and records an image, the user may record an image of the field from an agricultural road or a footpath between fields.

For example, in cases when a field cannot be entered easily such as a paddy field, or when an overall image of the field is recorded to enable overall confirmation of growth of the entire crop, the user often records an image from outside the field such as from an agricultural road or a footpath between fields. Further, if the accuracy of the GPS is poor, even if the image is recorded from within the field, the GPS information may indicate a position outside the field. Thus, the work support apparatus 101 searches for a field that is within a given range of the photographic point indicated by the position information concerning the mobile terminal 102.

(3) If multiple fields are retrieved, the work support apparatus 101 correlates and displays on a display 120, the image P and annunciation information indicating that multiple fields are present. Here, annunciation information is, for example, a character string or symbol indicating that multiple fields related to the image P are present or a single field related to the image P cannot be identified.

Further, in (3) above, if 1 field is retrieved, the work support apparatus 101 correlates and displays on the display 120, identification information of the field with the image P. The identification information of the field may be, for example, the field name or address identifying field.

In the example depicted in FIG. 1, images Pa and Pb recorded by the mobile terminal 102 are displayed on the display 120 of the work support apparatus 101.

In this example, an image Pa is a picture of cabbage cultivated in a field, recorded from a footpath between fields to show the state of growth. Therefore, multiple fields near the photographic point of the image Pa are retrieved and consequently, annunciation information 130 is appended to the image Pa and displayed on the display 120. The annunciation information 130 is a message indicating that no field has been identified and thus, on-site confirmation is necessary.

An image Pb is a picture of cabbage recorded from inside a field to show the state of growth. Therefore, 1 field that includes the photographic point of the image Pb is retrieved, and identification information 140 is appended to the image Pb and displayed on the display 120. The identification information 140 is the field name field “bbb” identifying the field.

According to the work support apparatus 101 described above according to the first embodiment, a group of fields dispersed among various areas can be searched, for field that is within a given range of a position indicated by the position information that is for the mobile terminal 102 and is appended to the image P. Thus, a field that is near the photographic point can be searched for, taking into account, cases where the image P is recorded from outside the field such as from an agricultural road or footpath between fields.

According to the work support apparatus 101, if multiple fields that are near the photographic point are retrieved, annunciation information indicating that multiple fields related to the image P can be correlated with the image P and displayed. Thus, concerning the correlation of the image P and a field, images requiring on-site confirmation can be easily distinguished, enabling improved efficiency of user editing.

Next, a work support system 200 according to a second embodiment will be described. Herein, the description of aspects identical to those of the first embodiment is omitted.

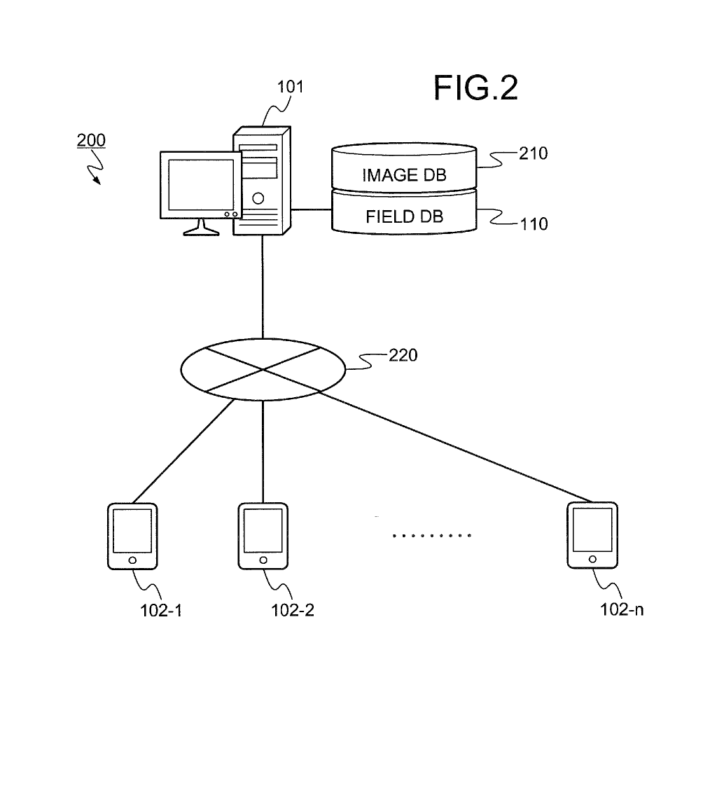

FIG. 2 is a diagram depicting a system configuration example of the work support system 200 according to the second embodiment. In FIG. 2, the work support system 200 includes the work support apparatus 101 and mobile terminals 102-1 to 102-n (in FIG. 2, 3 are depicted). In the work support system 200, the work support apparatus 101 and the mobile terminals 102-1 to 102-n are connected by a network 220 such as the internet, a local area network (LAN) and a wide area network (WAN). A communication line linking the work support apparatus 101 and the mobile terminals 102-1 to 102-n may be wireless or wired.

The work support apparatus 101 includes an image DB 210 and manages the images P recorded by the mobile terminals 102-1 to 102-n used by users engaged in the farm work. The mobile terminals 102-1 to 102-n correspond to the mobile terminal 102 depicted in FIG. 1.

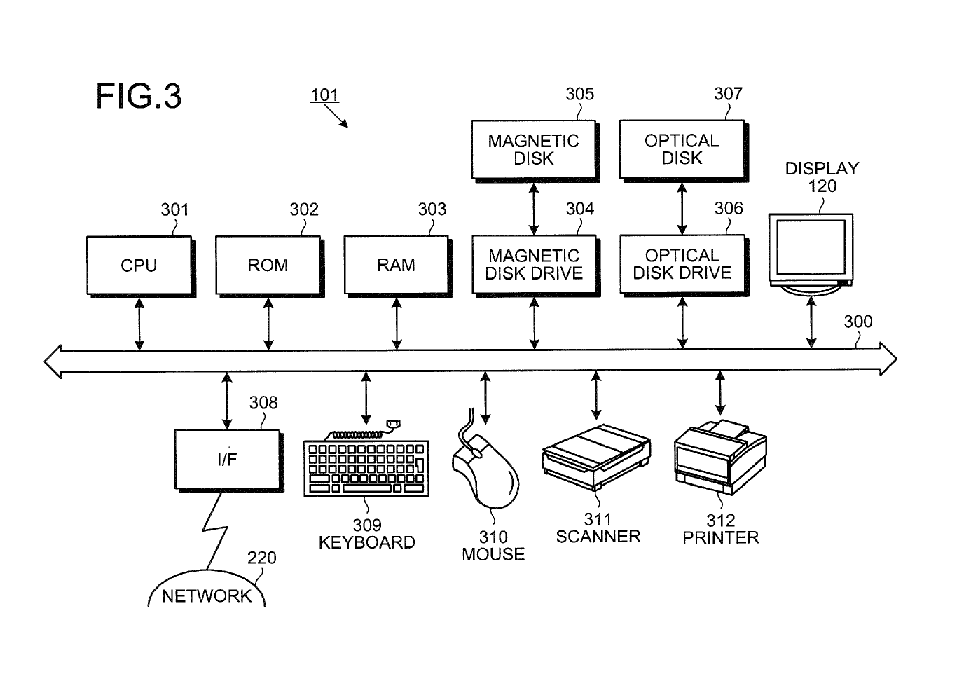

FIG. 3 is a block diagram of an example of a hardware configuration of the work support apparatus 101 according to the second embodiment. In FIG. 3, the work support apparatus 101 includes a central processing unit (CPU) 301, read-only memory (ROM) 302, random access memory (RAM) 303, a magnetic disk drive 304, a magnetic disk 305, an optical disk drive 306, an optical disk 307, the display 120, an interface (I/F) 308, a keyboard 309, a mouse 310, a scanner 311, and a printer 312, respectively connected by a bus 300.

The CPU 301 governs overall control of the work support apparatus 101. The ROM 302 stores programs such as a boot program. The RAM 303 is used as a work area of the CPU 301. The magnetic disk drive 304, under the control of the CPU 301, controls the reading and writing of data with respect to the magnetic disk 305. The magnetic disk 305 stores data written thereto under the control of the magnetic disk drive 304.

The optical disk drive 306, under the control of the CPU 301, controls the reading and writing of data with respect to the optical disk 307. The optical disk 307 stores data written thereto under the control of the optical disk drive 306, the data stored on the optical disk 307 being read out by a computer.

The display 120 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 120.

The I/F 308 is connected to the network 220 via a communication line, and is further connected to external apparatuses via the network 220. The I/F 308 administers an internal interface with the network 220, and controls the input and output of data with respect to external apparatuses. For example, a modem or a LAN adaptor may be employed as the I/F 308.

The keyboard 309 includes, for example, keys for inputting letters, numerals, and various instructions and performs the input of data. Alternatively, a touch-panel-type input pad or numeric keypad, etc. may be adopted. The mouse 310 is used to move the cursor, select a region, or move and change the size of windows. A track ball or a joy stick may be adopted provided each respectively has a function similar to a pointing device.

The scanner 311 optically reads an image and takes in the image data into the work support apparatus 101. The scanner 311 may have an optical character reader (OCR) function as well. The printer 312 prints image data and text data. The printer 312 may be, for example, a laser printer or an ink jet printer.

The configuration of the work support apparatus 101 may omit the optical disk drive 306, the scanner 311, and/or the printer 312. Further, the mobile terminals 102-1 to 102-n depicted in FIG. 2 can be implemented by the same hardware configuration described above for the work support apparatus 101.

Next, the contents of various DBs (the field DB 110, the image DB 210) of the work support apparatus 101 will be described. The various DBs 110 and 210, for example, are implemented by a storage device such as the RAM 303, the magnetic disk 305, and the optical disk 307 depicted in FIG. 3.

FIG. 4 is a diagram depicting an example of the contents of the field DB 110. In FIG. 4, the field DB 110 has fields for field IDs, field names, categories, sub-categories, cropping methods, growth stages, field properties, field position data, work log data, and material log data. By setting information into each of the fields, the field data 400-1 to 400-m of the fields F1 to Fm are stored as records.

In this example, field IDs are identifiers of the fields F1 to Fm that are dispersed over various areas. Hereinafter, an arbitrary field among the fields F1 to Fm will be indicated as a “field Fj” (j=1, 2, . . . , m). The field name is the name of a field Fj. The category is the type of crop under cultivation in the field Fj. The category may be, for example, irrigated rice, cabbage, carrots, etc.

The sub-category is a type within a single category. For example, a sub-category may be koshi-hikari (rice), hitomebore (rice), autumn/winter cabbage (cabbage), winter cabbage (cabbage), spring cabbage (cabbage). The cropping method is a system indicating combinations of conditions and/or techniques when a crop is cultivated. The cropping method may be, for example, direct seeding, transplanting, spring cultivation, summer cultivation, autumn cultivation, and winter cultivation.

The growth stage is the stage of growth of the crop cultivated in the field Fj. The growth stage may be, for example, a sowing phase, a germination phase, a growth phase, a maturation phase, and a harvesting phase. The field property indicates the shape and/or soil characteristics of the field Fj. A field property may be, for example, farmland, paddy field, flat terrain, mountain area, hilly area, low lying area, marshy area, etc.

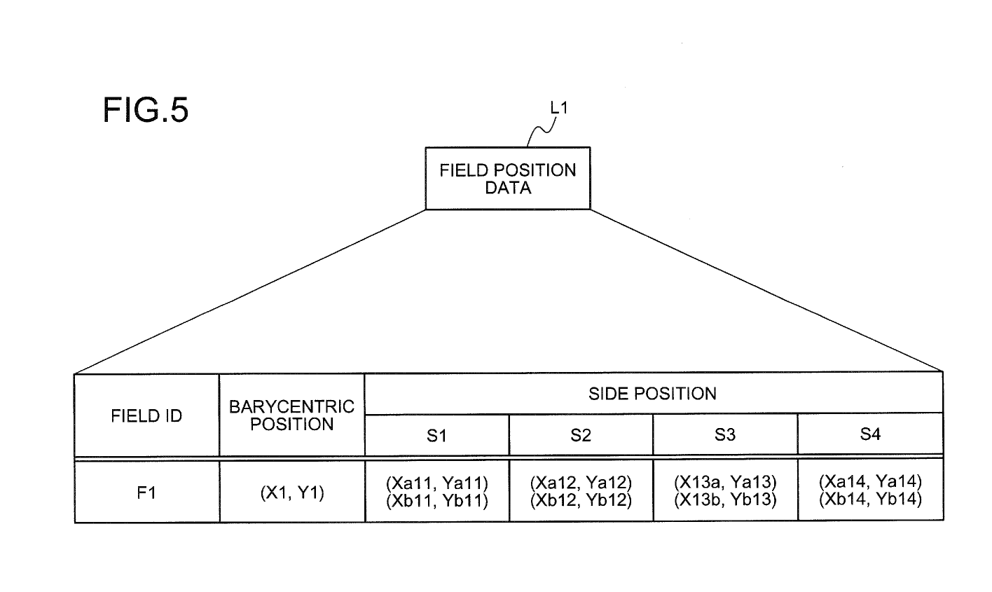

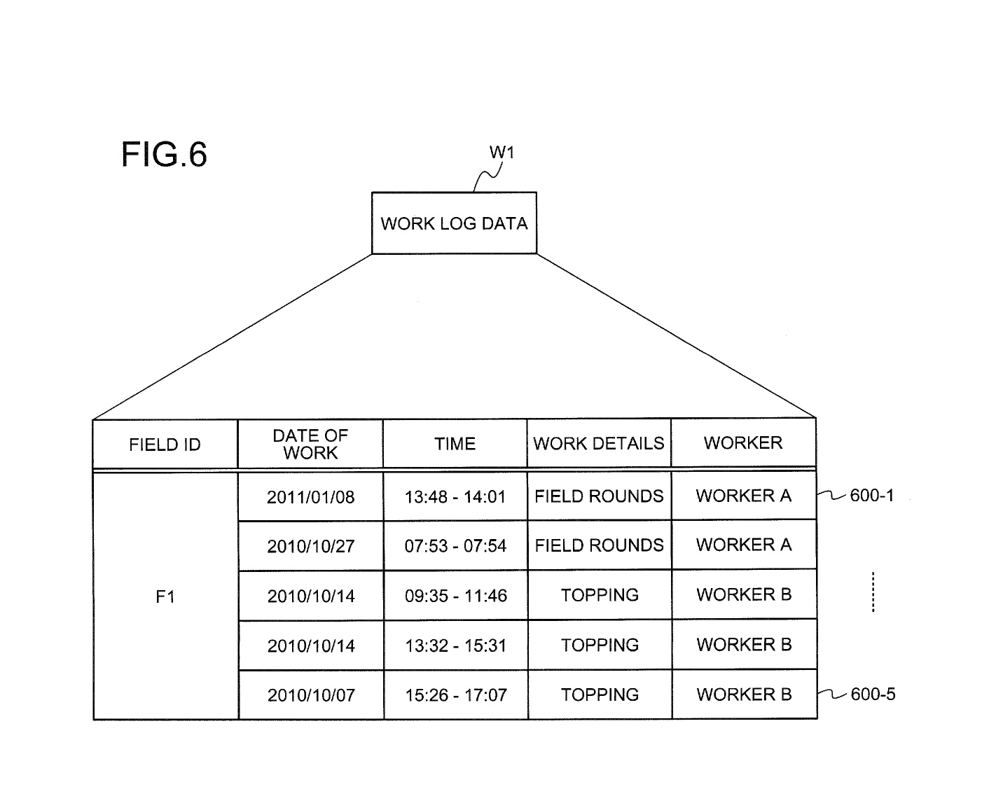

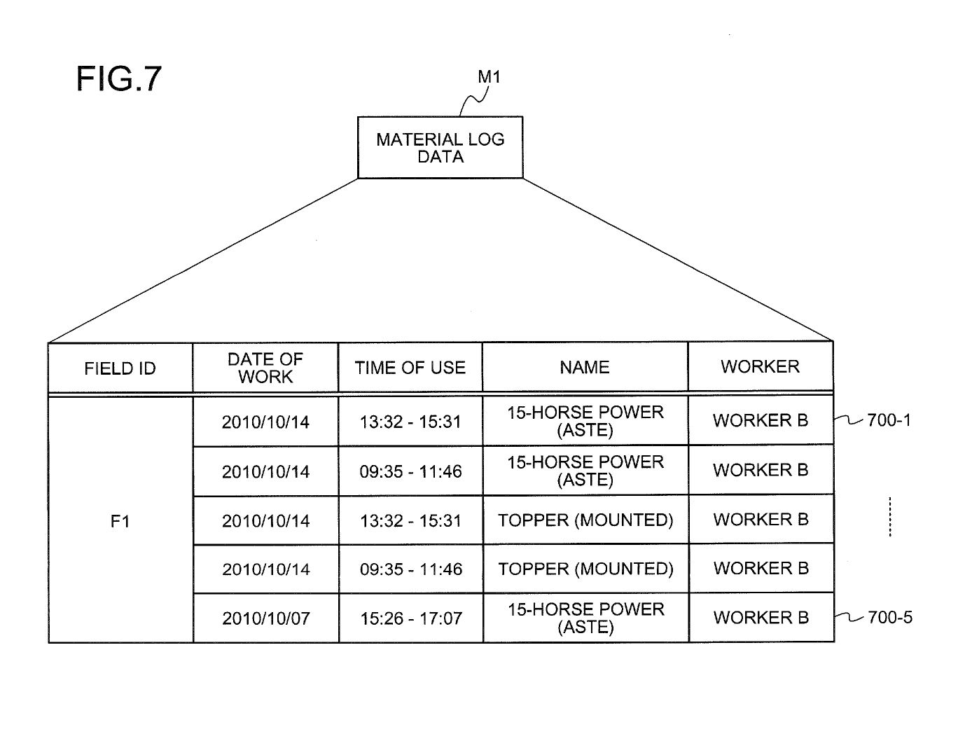

Field position data is information that indicates the position of the field Fj. Detailed description of the field position data will be given hereinafter with reference to FIG. 5. The work log data is information indicating the farm work carried out in the field Fj. Detailed description of the work log data will be given hereinafter with reference to FIG. 6. The material log data is information indicating farm equipment used to perform the farm work in the field Fj. Detailed description of the material log data will be given hereinafter with reference to FIG. 7.

Taking the field data 400-1 as an example, the field name “field A” of field F1, the category “cabbage”, the sub-category “autumn/winter cabbage”, the cropping method “autumn sowing”, the growth stage “sowing phase”, and the field property “farmland•sloped area” are indicated in the record. Further, the field position data L1, the work log data W1, and the material log data M1 are set.

Here, taking the field position data L1, the work log data W1, and the material log data M1 of field F1 as an example, concrete examples of field position data Lj, work log data Wj, and material log data Mj will be described.

First, an example of the field position data Lj will be described. Here, an example will be described in which the fields Fj mapped on a map are expressed by polygons. The map is drawing data that depicts a group of fields F1 to Fm reduced by a given percentage on a planar surface.

FIG. 5 is a diagram depicting an example of the field position data. In FIG. 5, the field position data L1 is information that in an X, Y coordinate system, indicates the barycentric position (X1, Y1) of field F1 and side positions of sides S1 to S4 of a polygon representing the field F1. The side positions of the sides S1 to S4 are coordinate positions of both ends of the sides S1 to S4. For example, the coordinate position of one end of the side S1 is (Xa11, Ya11) and the coordinate position of the other end is (Xb11, Yb11).

Provided each field is set in the same way, the direction of the X axis and the Y axis are irrelevant. For example, the X axis may be the longitudinal direction and the Y axis may be the latitudinal direction. Alternatively, assuming the location of the work support apparatus 101 as a center, the X axis may be an east/west axis, where the east is the positive axis; and the Y axis is a north/south axis, where the north is the positive axis.

FIG. 6 is a diagram depicting an example of work log data. In FIG. 6, the work log data W1 has fields for field IDs, dates of work, times, work details, and workers. By setting information into each of the fields, the work log data 600-1 to 600-5 are stored as records.

The field ID is the identifier of a field Fj. The date of work is the date on which the farm work was carried out in the field Fj. The time is the time that the farm work was carried out in the field Fj. The work details are details of the farm work carried out in the field Fj. Work details may be, for example, weeding, making field rounds, topping root vegetables, plowing, permanent planting, fertilizer application, pesticide application, and harvesting. The worker is the worker who carried out the farm work in the field Fj.

Taking the work log data 600-1 as an example, the work details “make field rounds” and the worker “worker A” of the farm work carried out in the field F1 on the date “2011/01/08” at the time “13:48-14:01” are indicated. The work log data Wj is updated each time new farm work is performed in the field Fj.

FIG. 7 is a diagram depicting an example of material log data. In FIG. 7, the material log data M1 includes fields for field IDs, dates of work, times of use, names, and workers. By setting information into each of the fields, material log data 700-1 to 700-5 are stored as records.

The field ID is the identifier of a field Fj. The date of work is the date on which the farm work was carried out in the field Fj. The time of use is the time that the farm equipment was used during the farm work. The name is the name of the farm equipment used during the farm work. The worker is the worker who carried out the farm work in the field Fj.

Taking the material log data 700-1 as an example, the name of farm equipment “15-horse power (ASTE)” used in the field F1 and the worker “worker B” who carried out the farm work on the date “2010/10/14” at the time “13:32-15:31” are indicated. The material log data Mj is updated each time new farm equipment is used in the farm work on the field Fj.

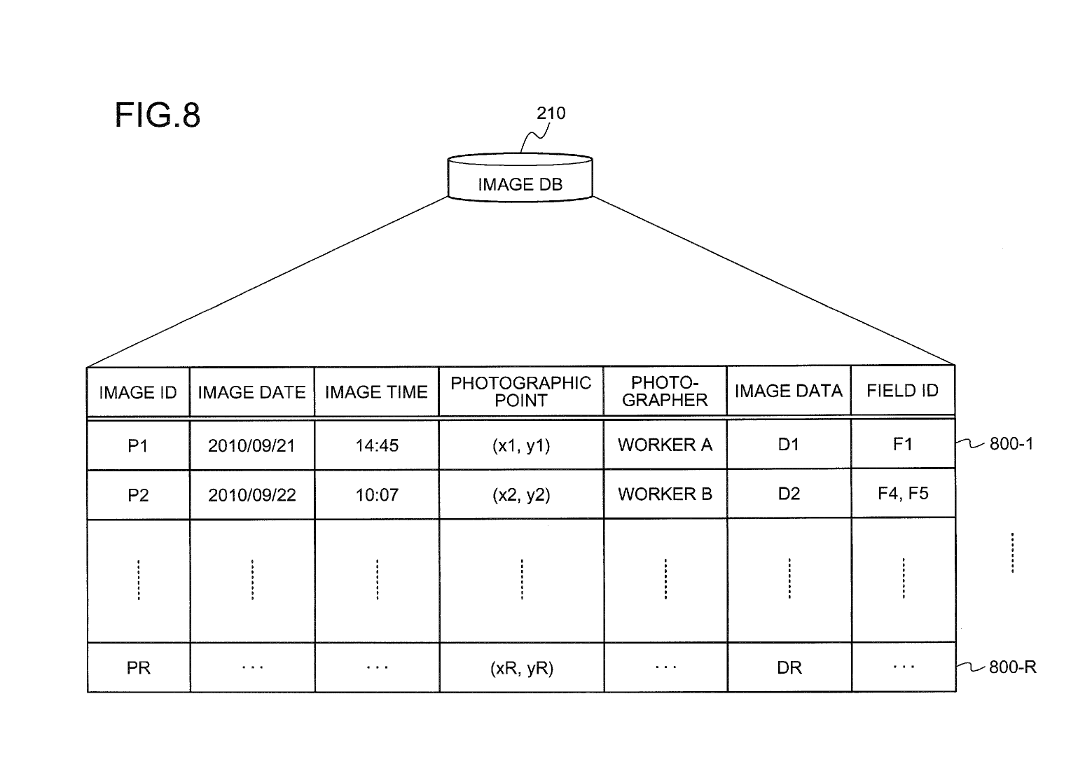

FIG. 8 is a diagram depicting an example of the image DB 210. In FIG. 8, the image DB 210 includes fields for image IDs, image dates, image times, photographic points, photographer, image data, and field IDs. By setting information into each of the fields, the image recording data 800-1 to 800-R are stored as records.

The image ID is the identifier of the image P recorded by the mobile terminal 102-i. The image date is the date on which the image P was recorded. The image time is the time at which the image P was recorded. The photographic point is the position indicated by the position information of the mobile terminal 102-i at the time of recording of the image P. The photographer is the worker that recorded the image P. The image data is the image data of the image P. The field ID is the identifier of the field Fj related to the image P.

Taking the image recording data 800-1 as an example, the photographic point “x1, y1” of the image P1 and the photographer “worker A” are indicated for the image P1 recorded on the date “2010/9/21” at the time “14:45”. Further, image data D1 of the image P1 and the field ID “F1” of the field related to the image P1 are set. Immediately after an image is recorded, a record is generated, leaving the field for the field ID blank.

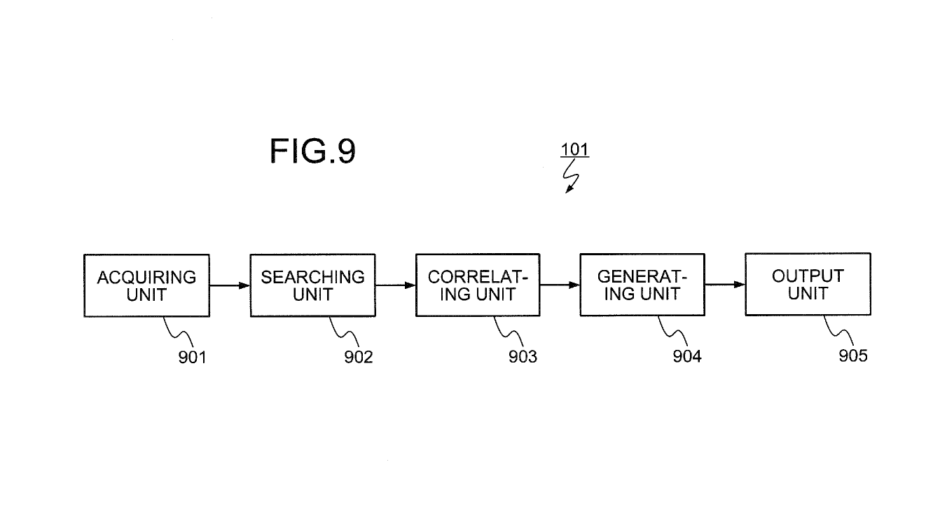

FIG. 9 is block diagram of a functional configuration of the work support apparatus 101 according to the second embodiment. In FIG. 9, the work support apparatus 101 includes an acquiring unit 901, a searching unit 902, a correlating unit 903, a generating unit 904, and an output unit 905. These functions (the acquiring unit 901 to the output unit 905), forming a control unit, are implemented, for example, by executing on the CPU 301, a program stored in a storage device such as the ROM 302, the RAM 303, the magnetic disk 305, and the optical disk 307 depicted in FIG. 3, or via the I/F 308. Process results of the functions are stored to a storage device such as the RAM 303, the magnetic disk 305, and the optical disk 307.

The acquiring unit 901 acquires an image Pr recorded by the mobile terminal 102-i. For example, the acquiring unit 901 may acquire the image Pr by receiving the image Pr from the mobile terminal 102-i and may further acquire the image Pr by a user input operation via the keyboard 309 and/or the mouse 310 depicted in FIG. 3. Here, an example of the image Pr will be described.

The mobile terminal 102-i has, for example, an authentication means and by authenticating the user, who is the photographer, by the authentication means, the mobile terminal 102-i can acquire an identifier that uniquely differentiates the users (photographers). Alternatively, if it is preliminarily determined which user will use which mobile terminal 102-i, based on the identifier of the mobile terminal 102-i that recorded the image Pr, the user (photographer) can be identified. Accordingly, when the acquiring unit 901 acquires the image Pr, the image Pr together with information concerning the photographer may be acquired from the mobile terminal 102-i and after acquiring the image Pr, the CPU 301 of the work support apparatus 101 may associate the image Pr and the information concerning the photographer.

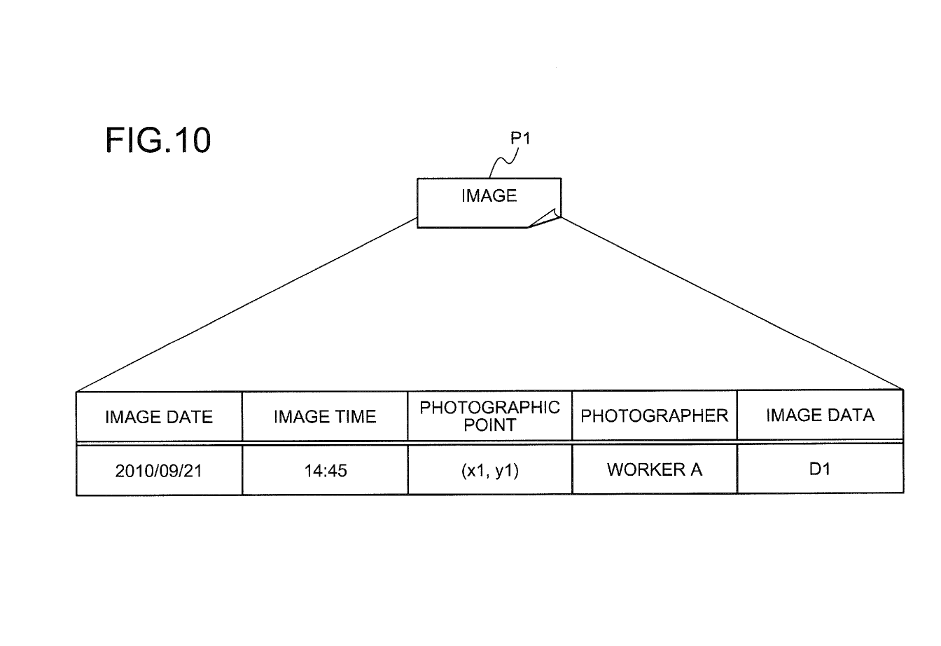

FIG. 10 is a diagram depicting an example of the data of an image. In FIG. 10, the image P1 includes the image date “2010/09/21”, the image time “14:45”, the photographic point “x1, y1”, the photographer “worker A” and the image data “D1”.

The acquired image Pr, for example, is stored in the image DB 210 depicted in FIG. 8. For example, the image date, the image time, the photographic point, the photographer, and the image data of the image P1 are set into the respective fields of the image DB 210, whereby the image recording data 800-1 (refer to FIG. 8) is stored as a new record.

The reference of description returns to FIG. 9. The searching unit 902, based on the position information of each of the fields Fj among the fields F1 to Fm, searches for a field Fj whose position substantially coincides with the position indicated by the position information of the mobile terminal 102-i included in the acquired image Pr.

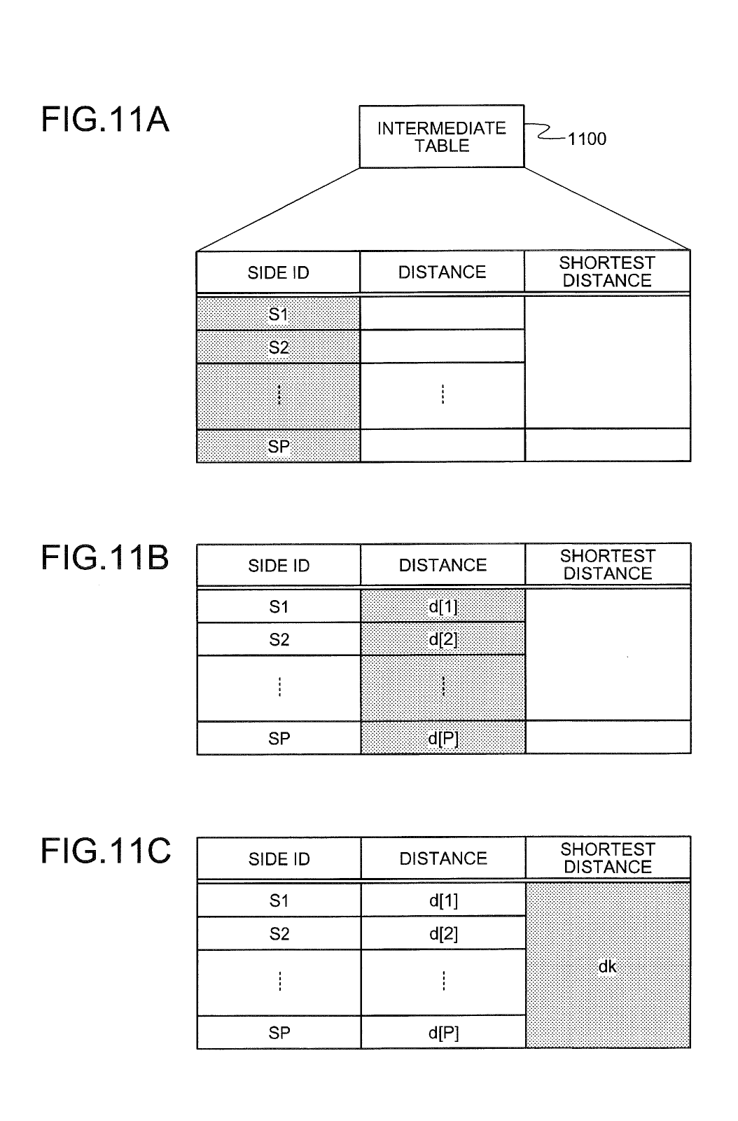

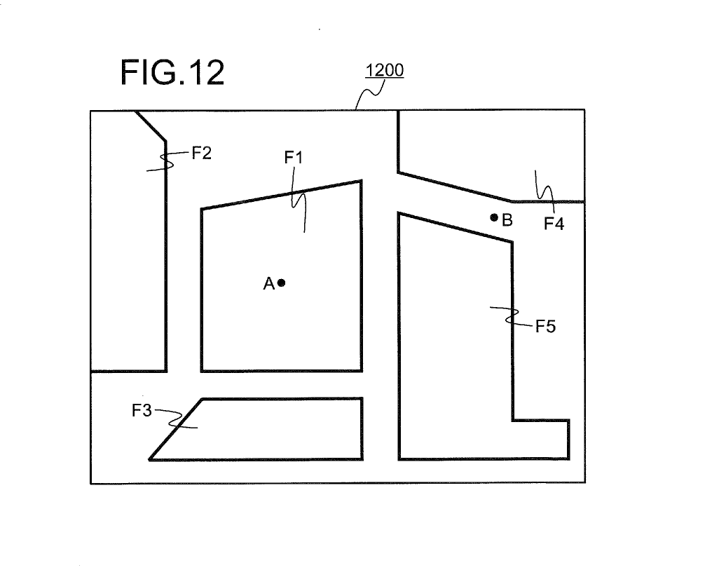

For example, the searching unit 902 refers to the field DB 110 depicted in FIG. 4, and searches among the group of fields F1 to Fm, for a field Fj that includes the position information of the mobile terminal 102-i. Here, if no field that includes the position information of the mobile terminal 102-i is retrieved, the searching unit 902 searches the group of fields F1 to Fm, for a field Fj that is within a given range of the position indicated by the position information of the mobile terminal 102-i. A process performed by the searching unit 902 will be described in detail with reference to FIGS. 11A, 11B, 11C, and 12.

The correlating unit 903 correlates the acquired image Pr and the retrieved field Fj. The correlated image Pr and field Fj are, for example, stored to the image DB 210 depicted in FIG. 8. For example, if the field F1 is retrieved concerning the image P1, in the image recording data 800-1, “F1” is set in the field for the field ID.

The generating unit 904 based on the correlated image Pr and field Fj, generates display data Hr for the image Pr. The display data Hr is information indicating the image Pr and the field Fj related to the image Pr.

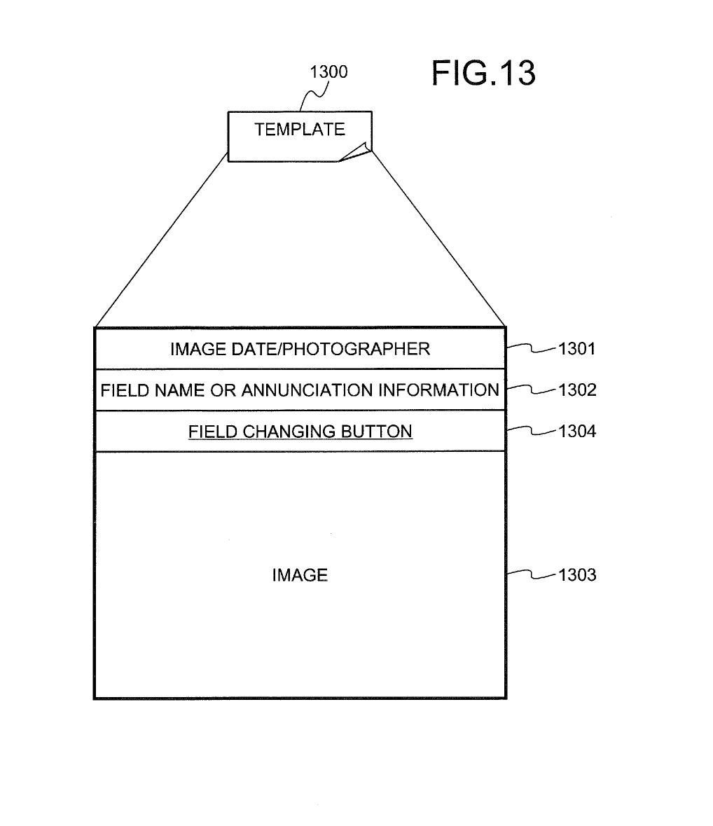

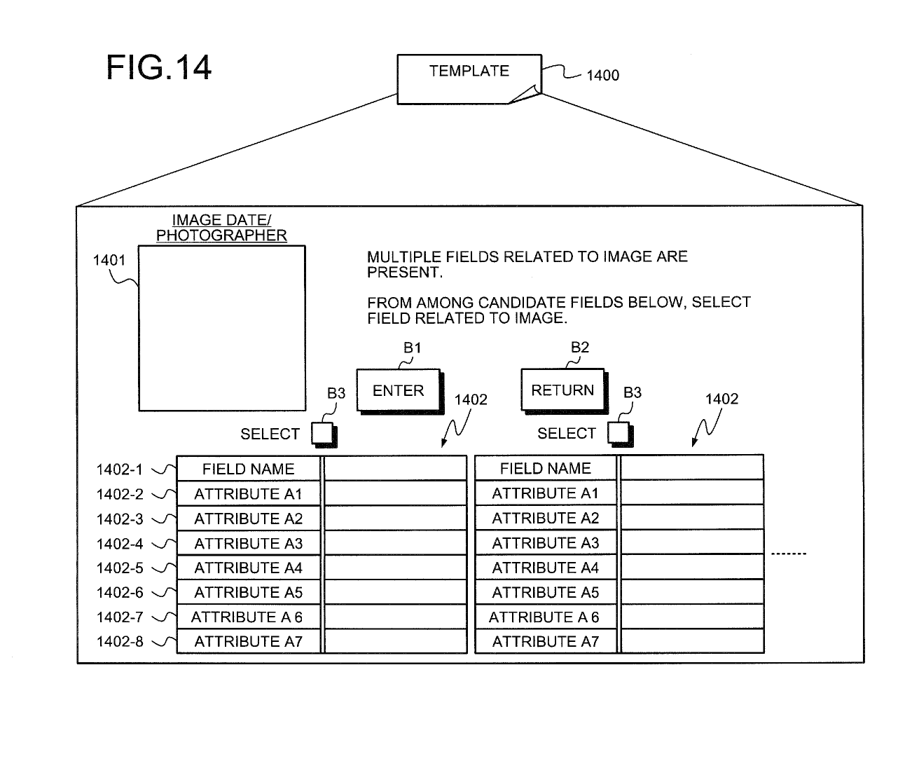

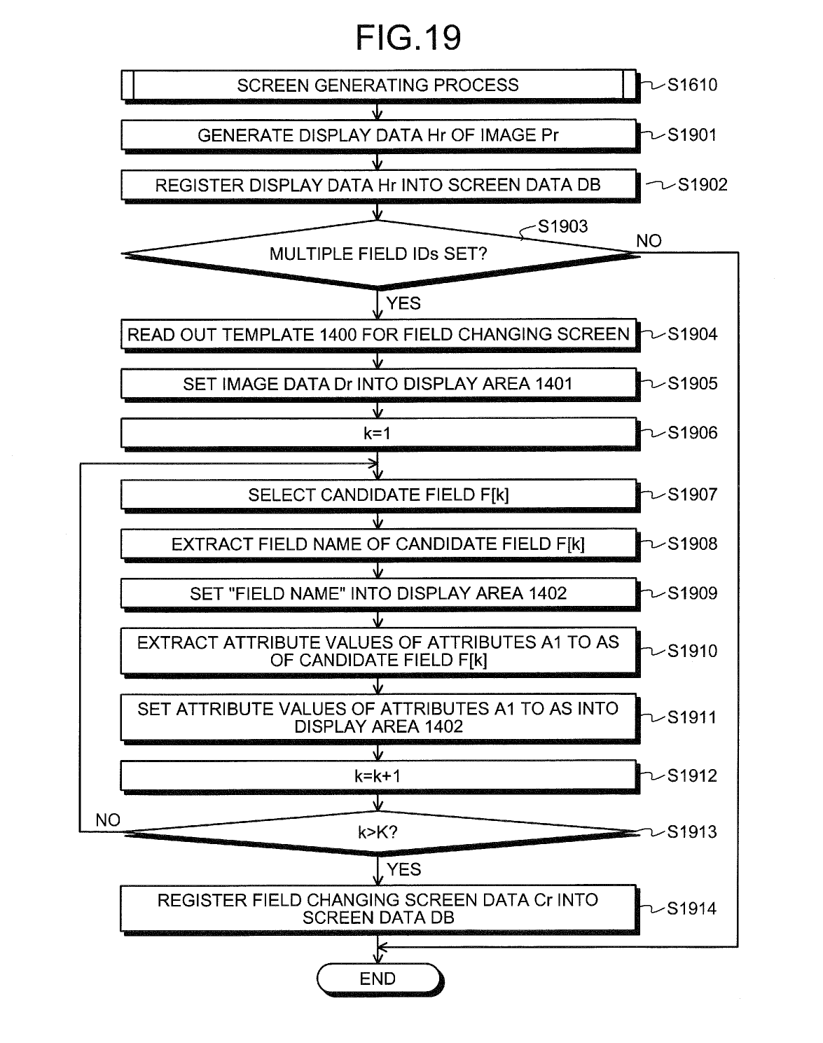

The generating unit 904, based on the display data H1 to HR of the images P1 to PR, generates an image list screen. The image list screen is a screen that shows the display data H1 to HR of the images P1 to PR in a list form (for example, refer to FIG. 20). A process performed by the generating unit 904 will be described in detail with reference to FIGS. 13 and 14.

The output unit 905 outputs generated results. For example, the output unit 905 outputs a field rounds result list screen 2000 described hereinafter and depicted in FIG. 20. The form of output may be, for example, display on the display 120, print out at the printer 312, and transmission to an external device via the I/F 308. Further, the output may be storage to a storage device such as the RAM 303, the magnetic disk 305, and the optical disk 307.

Here, an example of a process performed by the searching unit 902 to search for a field Fj that substantially coincides with the position information of the mobile terminal 102-i will be described.

For example, the searching unit 902 searches a set of polygons (hereinafter indicated as “polygons G1 to Gm”) representing each of the fields Fj among the group of fields F1 to Fm dispersed over various areas, for a polygon Gj that includes the photographic point (hereinafter “the photographic point of the image Pr”) indicated by the position information of the mobile terminal 102-i.

For example, based on the field position data L1 to Lm in the field DB 110, the searching unit 902 searches among the polygons G1 to Gm, for a polygon Gj that includes the photographic point of the image Pr. If a polygon Gj that includes the photographic point of the image Pr is retrieved, the field Fj that corresponds to the polygon Gj is the field Fj that substantially coincides with the position information of the mobile terminal 102-i, included in the image Pr.

On the other hand, if no polygon Gj that includes the photographic point of the image Pr is retrieved, the searching unit 902 searches among the fields F1 to Fm, for a field Fj whose barycentric position is within a given range of the photographic point of the image Pr. For example, the searching unit 902 searches for a field FJ whose barycentric position is within a given range, e.g., within a radius a (e.g., 50 [m]) of the photographic point of the image Pr regarded as a center.

Thus, the fields F1 to Fm can be narrowed down to a field near the photographic point of the image Pr. The radius α, for example, is preliminarily set and stored to a storage device such as the ROM 302, the RAM 303, the magnetic disk 305, and the optical disk 307, as a value preliminarily set by the user.

If no field Fj whose barycentric position is within the radius a about the photographic point of the image Pr is present, the searching unit 902 searches among the fields F1 to Fm, for a field Fj having a barycentric position whose distance to the photographic point is shortest.

In the description hereinafter, a field whose barycentric position is within the radius a about the photographic point of the image Pr will be referred to as “candidate fields F[1] to F[K]”. An arbitrary candidate field among the candidate fields F[1] to F[K] will be referred to as a “candidate field F[k]” (k=1, 2, . . . , K). Sides of the polygon G[k] representing the candidate field F[k] will be referred to as “sides S1 to SP”. An arbitrary side among the sides S1 to SP will be referred to as a “side Sp” (p=1, 2, . . . , P).

The searching unit 902 calculates for each side Sp of the polygon G[k] representing the candidate field F[k], the distance between the side Sp and the photographic point of the image Pr. For example, the searching unit 902, based on the field position data L[k] of the candidate field F[k], calculates for the candidate field F[k], a linear equation Ep for the side Sp of the polygon G[k].

Subsequently, the searching unit 902 calculates an intersection I of the line obtained by the linear equation Ep and a line that is orthogonal thereto and that originates from the photographic point of the image Pr. If the intersection I is on the side Sp, the searching unit 902 calculates the distance between the photographic point of the image Pr and the intersection I as the distance between the photographic point of the image Pr and the side Sp (hereinafter, “distance d[p]”).

On the other hand, if the intersection I is not on the side Sp, the searching unit 902 calculates the shorter distance among the distances da and db between the photographic point of the image Pr and each end of the side Sp, as the distance d[p] between the photographic point of the image Pr and the side Sp. The calculated distance d[p] of the side Sp is, for example, stored to an intermediate table 1100 depicted in FIGS. 11A, 11B, and 11C.

Next, the searching unit 902, among the distances d[1] to d[P] calculated for the sides S1 to SP of the polygon G[k], identifies the shortest distance as the distance dk between the photographic point of the image Pr and the candidate field F[k]. Thus, the shortest distance between the photographic point of the image Pr and each candidate field F[k] can be calculated as the distance dk. The identified distance dk, for example, is stored to the intermediate table 1100.

Here, an example of the intermediate table 1100 will be described. The intermediate table 1100 is generated for each of the candidate fields F[1] to F[K]. The intermediate table 1100, for example, is implemented by a storage device such as the RAM 303, the magnetic disk 305, and the optical disk 307.

FIGS. 11A, 11B, and 11C are diagrams depicting an example of the contents of the intermediate table. In FIGS. 11A, 11B, and 11C, the intermediate table 110 includes fields for side IDs, distances, and shortest distances. The side ID is the identifier of a side Sp of the polygon G[k]. The distance is the distance d[p] between the photographic point of the image Pr and the side Sp. The shortest distance is the shortest distance among the distances d[1] to d[P] calculated for the sides S1 to SP.

In FIG. 11A, consequent to the selection of an arbitrary candidate field F[k] among the candidate fields F[1] to F[K], the side IDs of each of the sides S1 to SP of the polygon G[k] are set into the side ID field of the intermediate table 1100.

In FIG. 11B, consequent to the calculation of the distances d[1] to d[P] of each of the sides S1 to SP of the polygon G[k], the distances d[1] to d[P] between the photographic point of the image Pr and each of the sides Sp are set into the distance field of the intermediate table 1100.

In FIG. 11C, consequent to the identification of the shortest distance among the distances d[1] to d[P], the distance dk between the photographic point of the image Pr and the candidate field F[k] is set into the shortest distance field of the intermediate table 1100.

The searching unit 902 searches among the candidate fields F[1] to F[K], for a candidate field F[k] for which the distance dk is less than or equal to a threshold β. The threshold β, for example, is preliminarily set and stored to a storage device such as the ROM 302, the RAM 303, the magnetic disk 305, and the optical disk 307 as a value set by the user. For example, the threshold β is set on the order of 5 to 10 [m] representing the width of an agricultural road or a footpath between fields.

Thus, if the photographic point of the image Pr is outside the field, such as on an agricultural road or footpath between fields, fields adjacent to the agricultural road or footpath can be retrieved as candidate fields. If no candidate field F[k] for which the distance dk is less than or equal to the threshold β is present, the searching unit 902 may retrieve the candidate field F[k] for which the distance dk is shortest among the candidate fields F[1] to F[K].

FIG. 12 is a diagram depicting an example of searching for a field. In FIG. 12, the fields F1 to F5 (polygons G1 to G5) are displayed on a map 1200. In the figure, a portion of the map 1200 has been extracted and is displayed.

A point A on the map 1200 represents the photographic point of the image P1. The point A is included in the field F1. In this case, the field F1, which includes a photographic point A is retrieved as a field substantially coinciding with the photographic point A of the image P1. As a result, “F1” is set into the field ID field of the image recording data 800-1 depicted in FIG. 8.

A point B on the map 1200 represents the photographic point of the image P2. The point B is on an agricultural road between the field F4 and the field F5. In this case, the fields F4 and F5, which are near a photographic point B, are retrieved as fields substantially coinciding with the photographic point B of the image P2. As a result, “F4 and F5” are set into the field ID field of the image recording data 800-2.

The position information (e.g., the GPS position information) acquired by the mobile terminal 102-i may include some margin of error. Thus, prior to searching for a field Fj substantially coinciding with the photographic point of the image Pr, the searching unit 902 may correct the position information indicating the photographic point of the image Pr.

For example, the acquiring unit 901 acquires the position information of the mobile terminal 102-i at given intervals (e.g., 2-minute intervals). The searching unit 902 uses the position information of the mobile terminal 102-i acquired around the image time of the image Pr and corrects the position information indicating the photographic point of the image Pr.

For example, the searching unit 902 calculates a distance 11 between the photographic point of the image Pr and the position indicated by the position information of the mobile terminal 102-i acquired just before the image time of the image Pr. The searching unit 902 further calculates a distance 12 between the photographic point of the image Pr and the position indicated by the position information of the mobile terminal 102-i acquired just after the image time of the image Pr.

If the calculated distances 11, 12 are greater than or equal to a given value (e.g., 10 [m]), the searching unit 902 determines that the photographic point of the image Pr includes some margin of error and corrects the position information that indicates the photographic point of the image Pr. For example, the searching unit 902 may calculate, as the corrected photographic point of the image Pr, the average of the photographic point of the image Pr and the positions indicated by the position information of the mobile terminal 102-i acquired multiple times (e.g., 4) before and after the image time of the image Pr.

Thus, the margin of error included in the position information (e.g., GPS position information) of the mobile terminal 102-i can be reduced.

Here, an example of a process by the generating unit 904 will be described. First, a template used for generating the display data Hr of the image Pr will be described.

FIG. 13 is a diagram depicting an example of a display data template. In FIG. 13, a template 1300 is a model of the display data Hr and, includes display areas 1301 to 1303 and a field changing button 1304. In this example, the display area 1301 is an area for displaying the “image date” and “photographer” of the image Pr.

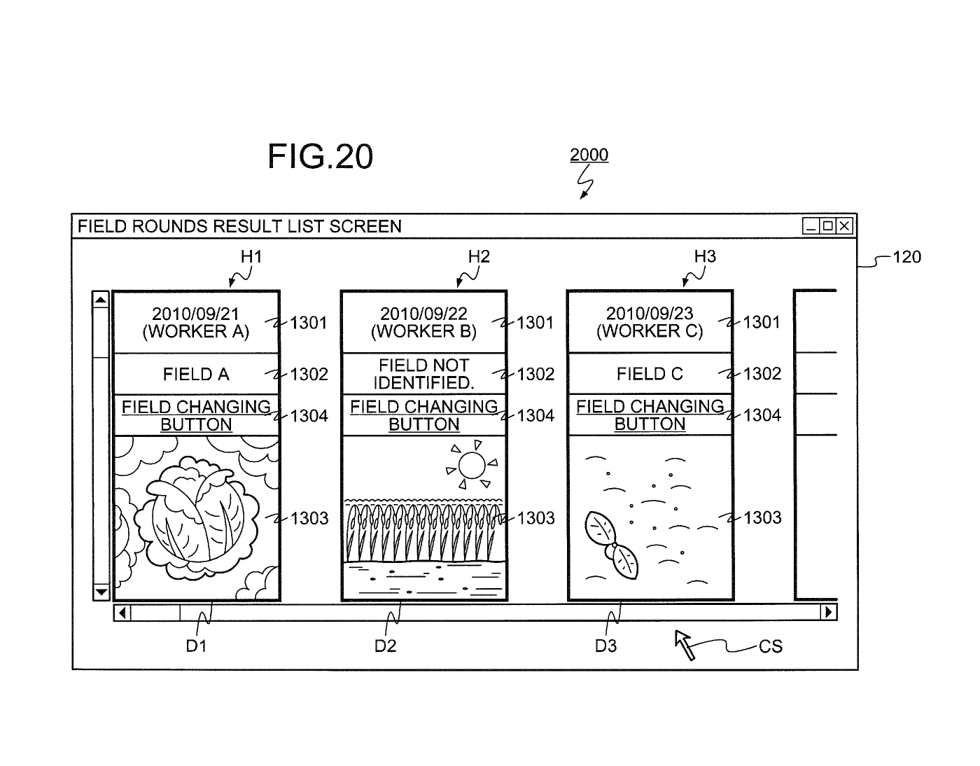

The display area 1302 is an area for displaying the “field name” of a field Fj related to the image Pr, or for displaying “annunciation information” indicating that multiple fields related to the image Pr are present. The display area 1303 is an area for placing the image Pr. The field changing button 1304 is a button for transitioning to a field changing screen (e.g., a field changing screen 2100 described hereinafter with reference to FIG. 21) for changing the field related to the image Pr.

The template 1300, for example, is stored in a storage device such as the ROM 302, the RAM 303, the magnetic disk 305, and the optical disk 307. Further, the design and the layout of the template 1300 can be arbitrarily changed.

The generating unit 904, based on the image recording data 800-r in the image DB 210, sets information in each of the display areas 1301 to 1303 of the template 1300 and thereby, generates the display data Hr of the image Pr. For example, the generating unit 904 sets into the display area 1301, the “image date” and the “photographer” identified from the image recording data 800-r.

The generating unit 904 sets into the display area 1302, the “field ID” identified from the image recording data 800-r. Here, if multiple field IDs are identified, in place of the “field ID”, the generating unit 904 sets into the display area 1302, “annunciation information” indicating that multiple fields related to the image Pr are present. Further, the generating unit 904 sets into the display area 1303, the “image data” identified from the image recording data 800-r. Thus, the display data Hr of the image Pr can be generated.

Further, if multiple field IDs are identified from the image recording data 800-r, the generating unit 904 generates field changing screen data Cr for the image Pr. The field changing screen is a screen enabling the user (by a user input operation) to select from among multiple candidate fields related to the image Pr, a field shown in the image Pr.

For example, the generating unit 904, based on a template 1400 of the field changing screen depicted in FIG. 14, can generate the field changing screen data Cr for the image Pr. Here, the template 1400 of the field changing screen will be described.

FIG. 14 is a diagram depicting an example of a template for the field changing screen. In FIG. 14, the template 1400 is a model of a field changing screen and, includes display areas 1401 and 1402 and various buttons B1 to B3. In this example, the display area 1401 is an area for placing the image Pr.

The display area 1402 is an area for displaying candidate field data of the candidate field F[k] related to the image Pr. For example, the display area 1402 includes the display area 1402-1 for displaying the field name of the candidate field F[k] related to the image Pr, and a display area (e.g., display areas 1402-2 to 1402-8) for displaying attribute values of attributes characterizing the candidate field F[k]. The display area 1402 is provided for each candidate field F[k] related to the image Pr. The various buttons B1 to B3 will be described hereinafter with reference to FIG. 21.

The number of and the details of the attributes characterizing the candidate field F[k] can be arbitrarily set. In the description hereinafter, attributes characterizing the candidate field F[k] are indicated as “attributes A1 to AS” and an arbitrary attribute among the attributes A1 to AS is indicated as an “attribute As” (s=1, 2, . . . , S). Further, the attribute value of an attribute As is indicated as an “attribute value Vs[k]”.

Here, as the attributes A1 to AS characterizing the candidate field F[k], the attribute A1 “category”, the attribute A2 “sub-category”, the attribute A3 “cropping method”, the attribute A4 “growth stage”, the attribute A5 “work log”, the attribute A6 “material log”, and the attribute A7 “field property” are assumed to be set.

The generating unit 904 sets information into the display areas 1401 and 1402 of the template 1400 and thereby, can generate the field changing screen data Cr for the image Pr. For example, the generating unit 904 sets in the display area 1401, image data Dr identified from the image recording data 800-r.

The generating unit 904 extracts the “field name” from the field data 400-[k] of the candidate field F[k], in the field DB 110 and sets the “field name” in the display area 1402-1. The generating unit 904 extracts the “category” from the field data 400-[k] and sets the “category” in the display area 1402-2. Further, the generating unit 904 extracts the “sub-category” from the field data 400-[k] and sets the “sub-category” in the display area 1402-3.

The generating unit 904 extracts the “cropping method” from the field data 400-[k] and sets the “cropping method” in the display area 1402-4. The generating unit 904 extracts the “growth stage” from the field data 400-[k] and sets the “growth stage” in the display area 1402-5. Further, the generating unit 904 extracts the “work log” from a work log data W[k] of the candidate field F[k] and sets the “work log” the display area 1402-6.

The generating unit 904 extracts the “material log” from a material log data M[k] of the candidate field F[k] and sets the “material log” the display area 1402-7. Further, the generating unit 904 extracts the “field property” from the field data 400-[k] and sets the “field property” in the display area 1402-8. Here, an example of the extraction of the “work log” and the “material log” will be described.

Example of Work Log Extraction

The generating unit 904, for example, extracts from the work log data W[k], the “work details/worker” concerning the farm work that is performed in the candidate field F[k] just before the “image date/image time” identified from the image recording data 800-r. The generating unit 904 sets the extracted “work details/worker” as the “work log” in the display area 1402-6.

As one example, the “image date/image time” identified from the image recording data 800-r is assumed to be “2010/10/14/11:50”, and the work log data W[k] is assumed to be the work log data W1 depicted in FIG. 6. In this case, the generating unit 904 extracts the work details “topping root vegetables” and the worker “worker B” related to the farm work that is performed in the candidate field F1 just before the “image date/image time”. The generating unit 904 sets “topping root vegetables/worker B” in the display area 1402-6.

The “work details/worker” is not limited to that just before the “image date/image time”. For example, the generating unit 904 may extract multiple “work details/worker” that are before the “image date/image time”, or may extract the “work details/worker” that is just after the “image date/image time”. Further, a given interval (e.g., a 2-day period before and after the “image date”) that includes the “image date” may be specified and the generating unit 904 accordingly extracts the “work details/worker”.

Example of Material Log Extraction

The generating unit 904, for example, extracts from the material log data M[k], the “name/worker” concerning the farm equipment used in the farm work that is performed in the candidate field F[k] just before the “image date/image time” identified from the image recording data 800-r. The generating unit 904 sets the extracted “name/worker” as the “material log” in the display area 1402-7.

As one example, the “image date/image time” identified from the image recording data 800-r is assumed to be “2010/10/14/11:50”, and the material log data M[k] is assumed to be a material log data M1 depicted in FIG. 7. In this case, the generating unit 904 extracts the “15-horse power (ASTE)” and the worker “worker B” concerning the farm equipment used in the farm work that is performed in the candidate field F1 just before the “image date/image time”.

The generating unit 904 extracts the name “topper (mounted)” and the worker “worker B” concerning the farm equipment used in the farm work that is performed in the candidate field F1 just before the “image date/image time”. The generating unit 904 sets “15-horse power (ASTE)/worker B” and “topper(mounted)/worker B” in the display area 1402-7.

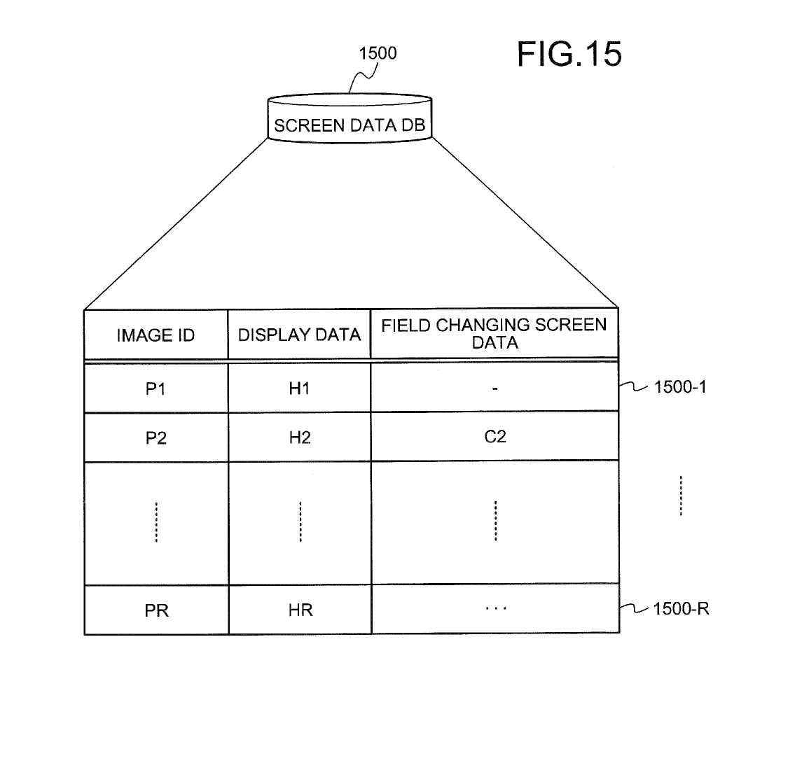

Thus, the field changing screen data Cr for the image Pr can be generated. The generated display data Hr and field changing screen data Cr for the image Pr are stored to, for example, a screen data DB 1500 depicted in FIG. 15. The screen data DB 1500 is implemented, for example, by a storage device such as the RAM 303, the magnetic disk 305, and the optical disk 307.

FIG. 15 is a diagram depicting an example of the contents of the screen data DB 1500. In FIG. 15, the screen data DB 1500 includes fields for image IDs, display data, and field changing screen data. By setting information into each field, screen data 1500-1 to 1500-R for each of the images P1 to PR are stored as records.

The image ID is the identifier of the image Pr. The display data is the display data Hr for the image Pr. The field changing screen data is the field changing screen data Cr for the image Pr. If the field changing screen data Cr for the image Pr has not been generated, the field for the field changing screen data indicates “-(Null)”.

The generating unit 904 refers to the screen data DB 1500 and generates a screen to be displayed on the display 120 (e.g., the field rounds result list screen 2000 and the field changing screen 2100 described hereinafter). For example, the generating unit 904, based on the display data H1 to HR in the screen data DB 1500, generates the field rounds result list screen 2000 depicted in FIG. 20. Further, the generating unit 904, based on the field changing screen data C2 in the screen data DB 1500, generates the field changing screen 2100 depicted in FIG. 21. An example of a screen displayed on the display 120 will be described with reference to FIGS. 20 to 22 hereinafter.

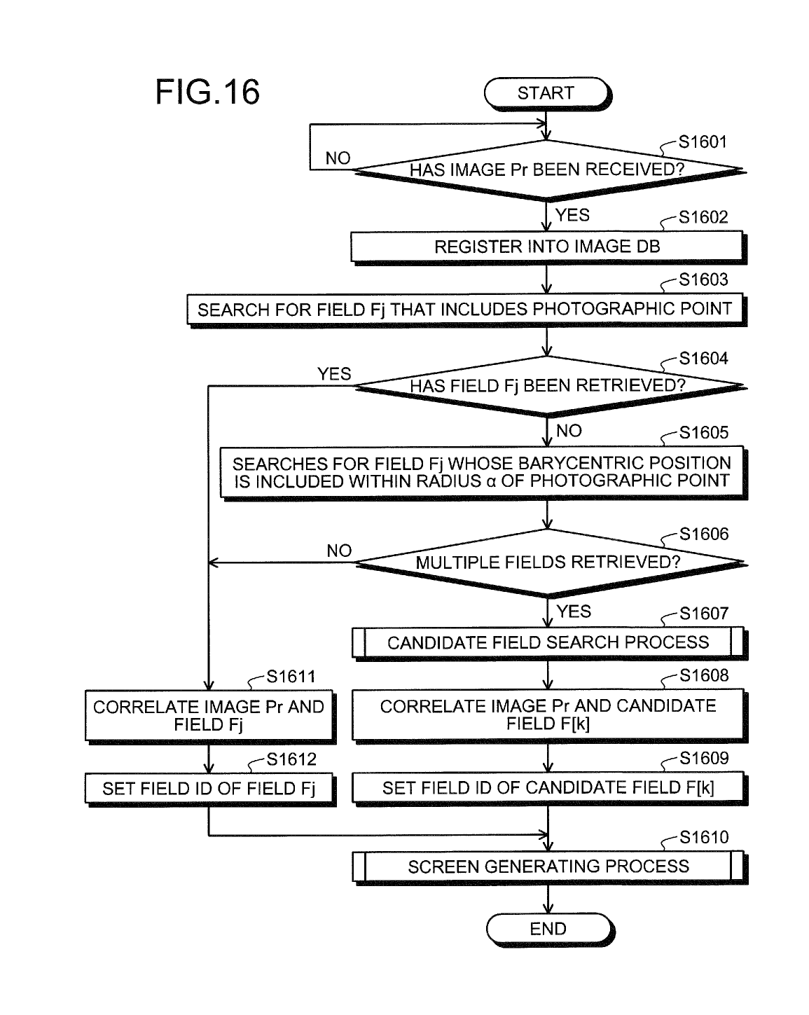

Next, a procedure of a work support process by the work support apparatus 101 according to the second embodiment will be described. FIG. 16 is a flowchart of an example of the procedure of the work support process by the work support apparatus 101 according to the second embodiment. In the flowchart depicted in FIG. 16, the acquiring unit 901 determines whether an image Pr recorded by the mobile terminal 102-i has been received (step S1601).

Here, the acquiring unit 901 awaits the receipt of an image Pr (step S1601: NO) and when an image Pr has been received (step S1601: YES), the acquiring unit 901 registers the image Pr into the image DB 210 (step S1602). As a result, the image recording data 800-r of the image Pr is registered into the image DB 210 as a new record.

The searching unit 902 searches the fields F1 to Fm, for a field Fj that includes the photographic point of the image Pr (step S1603). Here, if a field Fj that includes the photographic point of the image Pr is retrieved (step S1604: YES), the flow transitions to step S1611.

On the other hand, if no field Fj that includes the photographic point of the image Pr is retrieved (step S1604: NO), the searching unit 902 searches for a field Fj whose barycentric position is included within the radius a of the photographic point of the image Pr(step S1605).

Here, if multiple fields are retrieved (step S1606: YES), the searching unit 902 executes a candidate field search process and searches for a candidate field F[k] related to the image Pr (step S1607). The correlating unit 903 correlates the image Pr and the candidate field F[k] (step S1608).

The correlating unit 903 sets into the image recording data 800-r of the image DB 210, the field ID of the candidate field F[k] (step S1609). The generating unit 904 executes a screen generating process for the image Pr (step S1610), ending a series of operations according to the flowchart.

At step S1606, if one field Fj is retrieved (step S1606: NO), the correlating unit 903 correlates the image Pr and the field Fj (step S1611). The correlating unit 903 sets into the image recording data 800-r of the image DB 210, the field ID of the field Fj (step S1612), and the flow transitions to step S1610.

Thus, the image Pr and a field Fj related to the image Pr are correlated and registered into the image DB 210.

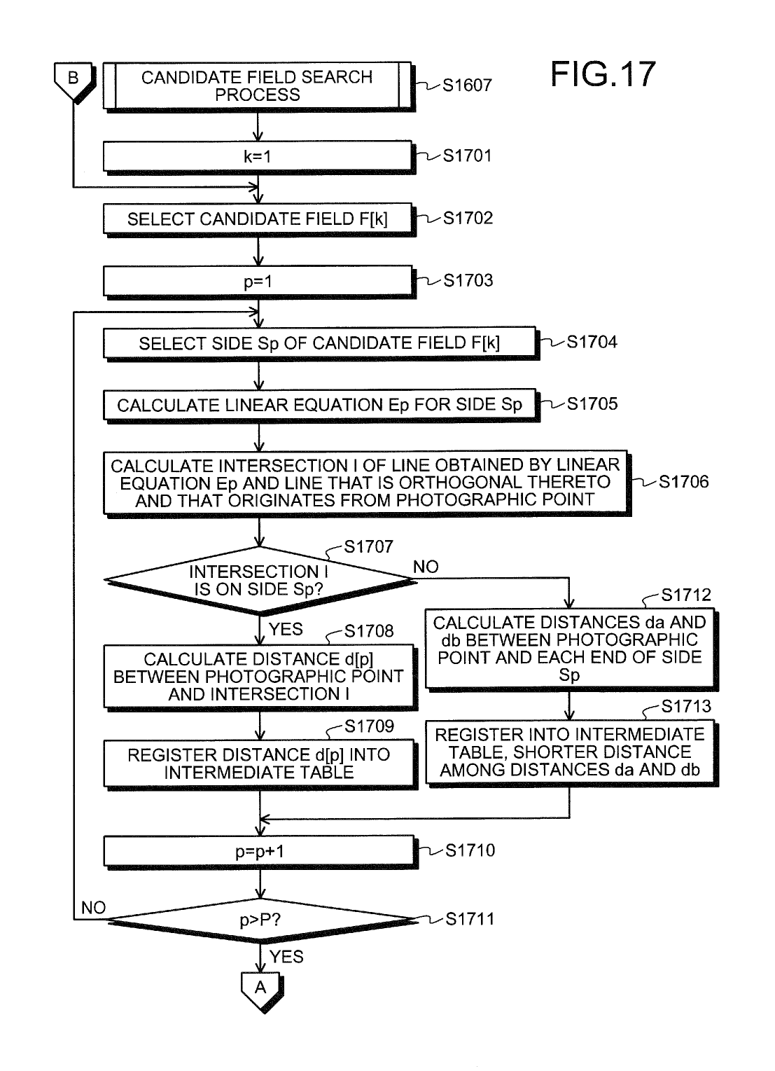

Next, a procedure of the candidate field search process at step S1607 in FIG. 16 will be described. FIGS. 17 and 18 are flowcharts of a procedure of the candidate field search process at step S1607.

As depicted in FIG. 17, the searching unit 902 sets “k” of a candidate field F[k] whose barycentric position is within the radius a of the photographic point of the image Pr as “k=1” (step S1701). The searching unit 902 selects from among the candidate fields F[1] to F[K], the candidate field F[k] (step S1702).

The searching unit 902 sets “p” of the side Sp of the polygon G[k] that represents the selected candidate field F[k], as “p=1” (step S1703). The searching unit 902 selects from among the sides S1 to SP of the polygon G[k], the side Sp (step S1704).

The searching unit 902, based on the field position data L[k] of the candidate field F[k], calculates the linear equation Ep for the selected side Sp (step S1705). The searching unit 902 calculates the intersection I of the line obtained by the linear equation Ep and a line that is orthogonal thereto and that originates from the photographic point of the image Pr (step S1706).

The searching unit 902 determines whether the calculated intersection I is on the side Sp (step S1707). If intersection I is on the side Sp (step S1707: YES), the searching unit 902 calculates the distance d[p] between the photographic point of the image Pr and the intersection I (step S1708), and registers the distance d[p] into the intermediate table 1100 (step S1709).

The searching unit 902 increments “p” of the side Sp (step S1710), and determines whether “p” exceeds “P” (step S1711). If “p” is less than or equal to “P” (step S1711: NO), the flow returns to step S1704. On the other hand, if “p” exceeds “P” (step S1711: YES), the flow transitions to step S1801 depicted in FIG. 18.

At step S1707, if the intersection I is not on the side Sp (step S1707: NO), the searching unit 902 calculates the distances da and db between the photographic point of the image Pr and each end of the side Sp (step S1712). The searching unit 902 registers into the intermediate table 1100, the distance d[p], which is the shorter distance among the distances da and db (step S1713), and the flow transitions to step S1710.

In FIG. 18, the searching unit 902 identifies the shortest distance among the distances d[1] to d[P] for the sides S1 to SP of the polygon G[k], as the distance dk between the photographic point of the image Pr and the candidate field F[k] (step S1801). The searching unit 902 registers the identified distance dk into the intermediate table 1100 (step S1802).

The searching unit 902 increments “k” of the candidate field F[k] (step S1803), and determines whether “k” exceeds “K” (step S1804). If “k” is less than or equal to “K” (step S1804: NO), the flow transitions to step S1702 depicted in FIG. 17.

On the other hand, if “k” exceeds “K” (step S1804: YES), the searching unit 902 searches the candidate fields F[1] to F[K], for a candidate field F[k] for which the distance dk is less than or equal to the threshold p (step S1805), and the flow transitions to step S1608 depicted din FIG. 16.

Thus, a candidate field F[k] near the photographic point of the image Pr can be searched for. Further, by setting the threshold β on the order of the width of an agricultural road or footpath between fields, if an image of the field Fj is recorded from an agricultural road or a footpath between fields, the candidate fields F[1] to F[K] adjacent to the agricultural road or footpath can be searched for.

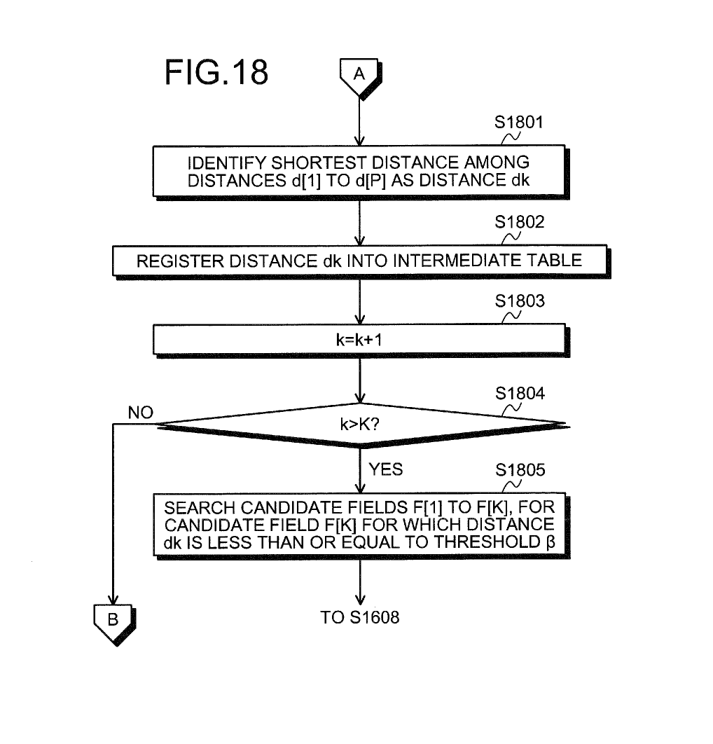

A procedure of the screen generating process at step S1610 depicted in FIG. 16 will be described. FIG. 19 is a flowchart of an example of a procedure of the screen generating process at step S1610.

In FIG. 19, the generating unit 904, based on the image recording data 800-r, sets information into the display areas 1301 to 1303 of the template 1300 and thereby, generates the display data Hr of the image Pr (step S1901). The generating unit 904 registers the generated display data Hr into the screen data DB 1500 (step S1902).

The generating unit 904 determines whether multiple field IDs have been set in the field ID field of the image recording data 800-r (step S1903). If multiple field ID have not been set (step S1903: NO), a series of operations according to the flowchart ends.

On the other hand, if multiple field IDs have been set (step S1903: YES), the generating unit 904 reads out the template 1400 for the field changing screen (step S1904). The generating unit 904 sets the image data Dr identified from the image recording data 800-r into the display area 1401 (step S1905).

The generating unit 904 sets “k” of the candidate field F[k] as “k=1” (step S1906), and selects the candidate field F[k] from among the candidate fields F[1] to F[K] (step S1907).

The generating unit 904 extracts the field name from the field data 400-[k] of the candidate field F[k] (step S1908), and sets the extracted field name into the display area 1402 (step S1909). The generating unit 904 extracts the attribute values of the attributes A1 to AS from the field data 400-[k] of the candidate field F[k] (step S1910), and sets the extracted attribute values of the attributes A1 to AS into the display area 1402 (step S1911).

The generating unit 904 increments “k” of the candidate field F[k] (step S1912), and determines whether “k” exceeds “K” (step S1913). If “k” is less than or equal to “K” (step S1913: NO), the flow returns to step S1907.

On the other hand, if “k” exceeds “K” (step S1913: YES), the generating unit 904 registers the field changing screen data Cr into the screen data DB 1500 (step S1914), ending a series of operations according to the flowchart.

Thus, the display data Hr of the image Pr can be generated. Further, if multiple field IDs have been set in the field ID field of the image recording data 800-r for the image Pr, the field changing screen data Cr for the image Pr can be generated.

Next, an example of a screen displayed on the display 120 will be described. The screen described in the example hereinafter, for example, is displayed on the display 120 when there is a screen display instruction consequent to a user input operation via the keyboard 309 and/or the mouse 310.

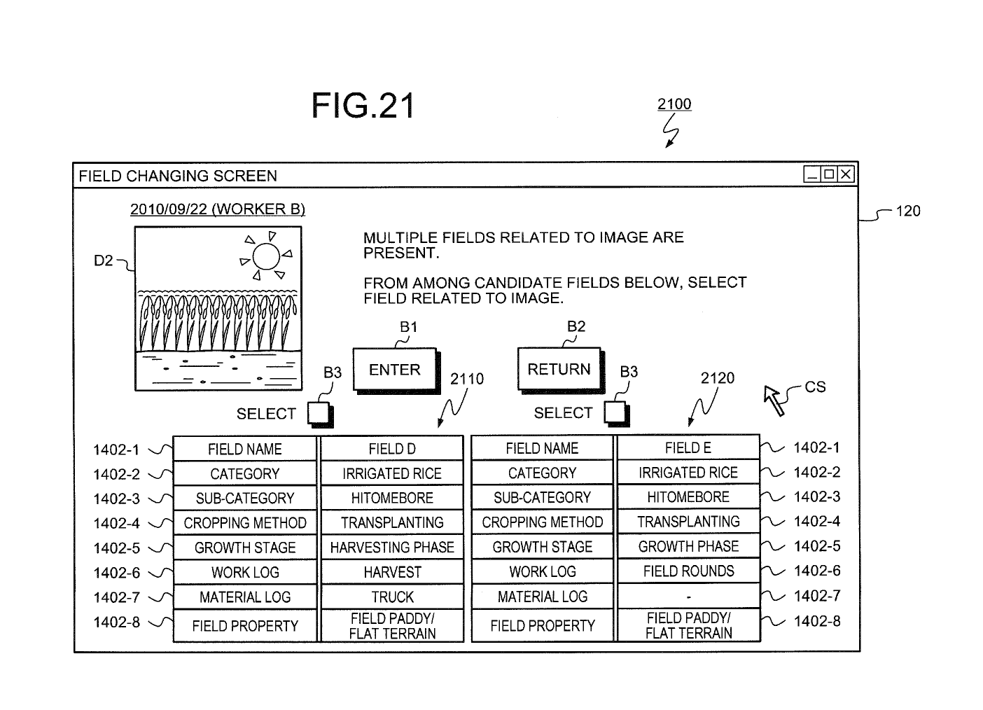

FIGS. 20 and 22 are diagrams depicting examples of a field rounds result list screen. FIG. 21 is a diagram depicting an example of a field changing screen (part 1). In FIG. 20, the display data H1 H3 are displayed on the field rounds result list screen 2000. The display data H1 is the display data of the image P1. The display data H2 is the display data of the image P2 and the display data H3 is the display data of the image P3.

In the field rounds result list screen 2000, for example, in the display area 1301 for the display data H1, the image date “2010/09/21” and the photographer “worker A” of the image P1 are set. Further, in the display area 1302 for the display data H1, the field name “field A” of the field F1 related to the image P1 is set. In the display area 1303 for the display data H1, the image data D1 of the image P1 is set.

On the field rounds result list screen 2000, for example, in the display area 1301 for the display data H2, the image date “2010/09/22” and the photographer “worker B” of the image P2 are set. In the display area 1302 for the display data H2, annunciation information “field not identified” indicating that multiple fields related to the image P2 are present is set. In the display area 1303 for the display data H2, the image data D2 of the image P2 is set.

The field rounds result list screen 2000 enables confirmation of the correlations of the images P1 and P3 with the fields A and C respectively based on the photographic points of the images P1 and P3. Further, from the annunciation information “field not identified” set in the display data H2 for the image P2, the presence of multiple fields related to the image P2 can be known.

Further, the user may specify an image date and/or worker prior to the display of the field rounds result list screen 2000, whereby the display data Hr displayed on the field rounds result list screen 2000 can be narrowed down.

On the field rounds result list screen 2000, when a cursor CS is moved by a user input operation and the field changing button 1304 for the display data H2 is clicked, the field changing screen 2100 for the image P2 can be displayed on the display 120.

In FIG. 21, on the field changing screen 2100, the image date/photographer of the image P2, the image data D2 of the image P2, and candidate field data 2110 and 2120 of the candidate fields F4 and F5 related to the image P2 are displayed.

In the display area 1402-1 for the candidate field data 2110, the field name “field D” of the candidate field F4 is set. In the display area 1402-2 for the candidate field data 2110, the category “irrigated rice” of the crop cultivated in the candidate field F4 is set. Further, in the display area 1402-3 for the candidate field data 2110, the sub-category “hitomebore” of the crop cultivated in the candidate field F4 is set.

In the display area 1402-4 for the candidate field data 2110, the cropping method “transplanting” of the crop cultivated in the candidate field F4 is set. Further, in the display area 1402-5 for the candidate field data 2110, the growth stage “harvesting phase” of the crop cultivated in the candidate field F4 is set.

In the display area 1402-6 for the candidate field data 2110, the work log “harvesting” for the farm work performed in the candidate field F4 is set. In the display area 1402-7 for the candidate field data 2110, the material log “truck” for equipment used in the farm work performed in the candidate field F4 is set. Further, in the display area 1402-8 for the candidate field data 2110, the field property “paddy field flat terrain” of the candidate field F4 is set.

For example, in the display area 1402-1 for the candidate field data 2120, the field name “field E” of the candidate field F5 is set. In the display area 1402-2 for the candidate field data 2120, the category “irrigated rice” of the crop cultivated in the candidate field F5 is set. Further, in the display area 1402-3 for the candidate field data 2120, the sub-category “hitomebore” of the crop cultivated in the candidate field F5 is set.

In the display area 1402-4 for the candidate field data 2120, the cropping method “transplanting” of the crop cultivated in the candidate field F5 is set. Further, in the display area 1402-5 for the candidate field data 2120, the growth stage “growth phase” of the crop cultivated in the candidate field F5 is set.

In the display area 1402-6 for the candidate field data 2120, the work log “making field rounds” for the farm work performed in the candidate field F5 is set. Further, in the display area 1402-8 for the candidate field data 2120, the field property “paddy field flat terrain” of the candidate field F5 is set. In the display area 1402-7 for the candidate field data 2120, the material log is not set (-).

The field changing screen 2100 enables the candidate fields D and E related to the image P2 to be identified. Further, attribute values of the attributes characterizing the candidate fields D and E can be confirmed. Thus, the attribute values of the attributes of each of the candidate fields D and E related to the image Pr can be confirmed while identifying the field that the image Pr shows.

In this example, between the candidate fields D and E, the category, the sub-category, and the cropping method of the crop under cultivation are identical. On the other hand, since the sowing phase and the permanent planting phase differ between the candidate field D and E, the growth stages of the crops differ. Further, since the tips of the rice shown in the image P2 are drooping, a user who sees this screen can discern that the growth stage of the rice is the “harvesting phase”. As a result, among the candidate fields D and E, in which the same crop is under cultivation, the user can identify the candidate field D for which the growth stage is “harvesting phase” as the field shown in the image P2.

On the field changing screen 2100, by moving the cursor CS via a user input operation and clicking any one of the select buttons B3 for the candidate field data 2110 and 2120, correlating of the image P2 and a candidate field can be performed. Further, on the field changing screen 2100, by clicking a return button B2, the field rounds result list screen 2000 depicted in FIG. 20 can be returned to, without the selection of a candidate field.

For example, on the field changing screen 2100, by clicking the select button B3 for the candidate field data 2110, the image P2 and the candidate field F4 can be correlated. Further, on the field changing screen 2100, by clicking the select button B3 for the candidate field data 2120, the image P2 and the candidate field F5 can be correlated.

Here, a case is assumed where on the field changing screen 2100, an enter button B1 is clicked after the select button B3 for the candidate field data 2110 has been clicked. In this case, the correlating unit 903 correlates the image P2 and the candidate field F4. As a result, in the image DB 210, the information of the field ID field of the image recording data 800-2 changes from “F4, F5” to “F4”.

Further, the generating unit 904 sets in the display area 1302 for the display data H2, the field name “field D” of the field F4. As a result, in the screen data DB 1500, the display data H2 is updated. The field rounds result list screen 2000 depicted in FIG. 22 is displayed on the display 120.

On the field rounds result list screen 2000 depicted in FIG. 22, in the display area 1302 for the display data H2m, the field name “field D” of the field F4 selected by a user input operation is set. In other words, on the field changing screen 2100, consequent to the selection of the field F4, the display contents of the display area 1302 for the display data H2 changes from “field not identified” to “field D”.

As described, the work support apparatus 101 according to the second embodiment enables the attribute value of the attribute As, which characterizes each of the candidate fields F[k], to be correlated with the image Pr and output, if multiple candidate fields F[k] related to the image Pr are retrieved.

Thus, the user can link the image Pr and a field Fj while confirming the attribute values of the attribute As for each of the candidate fields F[k] related to the image Pr.

Further, the work support apparatus 101 enables the category of a crop cultivated in each candidate field F[k] to be correlated with the image Pr and output.

Thus, the user can link the image Pr and a field Fj while comparing the contents of the image Pr and the category of the crop cultivated in each candidate field F[k]. As a result, when differing crops are cultivated among the candidate fields F[1] to F[K] during the same period, the field Fj in which the crop identified from the image Pr is cultivated can be easily identified.

The work support apparatus 101 enables the category and the sub-category of the crop cultivated in each candidate field F[k] to be correlated with the image Pr and output.

Thus, the user can link the image Pr and a field Fj while comparing the contents of the image Pr with the category and the sub-category of the crop cultivated in each candidate field F[k]. As a result, even when the categories of the crops under cultivation are identical, if the sub-categories among the candidate fields F[1] to F[K] differ, the field Fj in which the crop identified from the image Pr is cultivated can be easily identified.

The work support apparatus 101 enables the category, the sub-category, and the cropping method of the crop cultivated in candidate field F[k] to be correlated with the image Pr.

Thus, the user can link the image Pr and a field Fj while comparing the contents of the image Pr with the category, the sub-category, and the cropping method of the crop cultivated in each candidate field F[k]. As a result, even when the categories and the sub-categories of the crops under cultivation are identical, if the cropping methods differ among the candidate fields F[1] to F[K], the field Fj in which the crop identified from the image Pr is cultivated can be easily identified.

The work support apparatus enables the growth stage of the crop cultivated in each candidate field F[k] to be correlated with the image Pr.

Thus, the user can link the image Pr and a field Fj while comparing the contents of the image Pr and the growth stage of the crop cultivated in each candidate field F[k]. As a result, even when the categories, the sub-categories, and the cropping methods of the crops under cultivation are identical, if the sowing phase and the permanent planting phase differ among the candidate fields F[1] to F[K], the field Fj in which the crop identified from the image Pr is cultivated can be easily identified.

The work support apparatus 101 enables the work log of the farm work performed in each candidate field F[k] just before the image time of the image Pr to be correlated with the image Pr.

Thus, the user can link the image Pr and a field Fj while comparing the contents of the image Pr and the farm work performed in each candidate field F[k]. As a result, for example, even when the categories, the sub-categories, and the cropping methods of the crops udder cultivation are identical, if the farm work performed differs among the candidate fields F[1] to F[K], the field Fj in which the crop identified from the image Pr is cultivated can be easily identified. For example, the state of a field after harvest differs from the state of a field before harvest and therefore, if the state of a field can be determined from the image Pr, the field Fj shown in the image Pr can be easily identified.

The work support apparatus 101 enables the material log of the farm equipment used in the farm work performed in each candidate field F[k] before the image time of the image Pr to be correlated with the image Pr.

Thus, the user can link the image Pr and a field Fj while comparing the contents of the image Pr and the farm equipment used in the farm work performed in each candidate field F[k]. As a result, for example, even when the categories, the sub-categories, and the cropping methods of the crops under cultivation are identical, if the farm equipment used in the farm work differs among the candidate fields F[1] to F[K], the field Fj shown in the image Pr can be easily identified. For example, the state of field after plowing by a tractor differs from the state of a field before plowing and therefore, if the state of a field can be determined from the image Pr, the field Fj shown in the image Pr can be easily identified.

The work support apparatus 101 enables the field property of each candidate field F[k] to be correlated with the image Pr.

Thus, the user can link the image Pr and a field Fj while comparing the contents of the image Pr and the field property of candidate field F[k]. As a result, for example, even when the categories, the sub-categories, and the cropping methods of the crops under cultivation are identical, if the field properties differ among the candidate fields F[1] to F[K], field Fj shown in the image Pr can be easily identified. For example, since drainage differs for flat terrain and sloped terrain, if the drainage state of the field can be determined from the image Pr, the field Fj shown in the image Pr can be easily identified.

In a third embodiment, a case will be described where an attribute As characterizing a candidate field F[k] displayed on the field changing screen is determined. The description of aspects identical to those in the first and the second embodiments will be omitted.

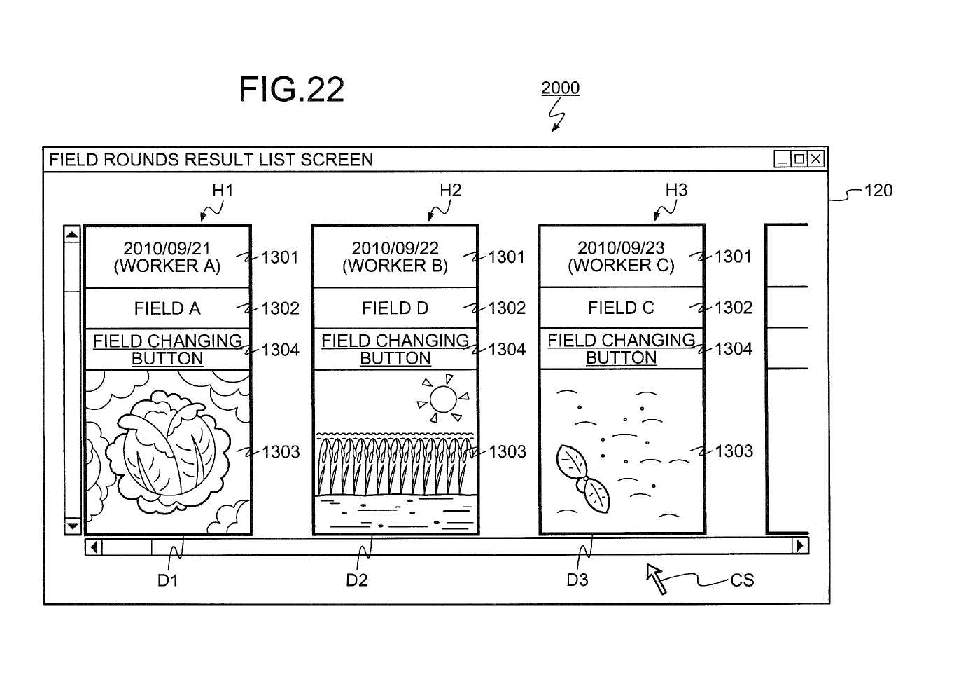

FIG. 23 is a diagram depicting a functional configuration of the generating unit 904 of the work support apparatus 101 according to the third embodiment. In FIG. 23, the generating unit 904 includes a selecting unit 2301, a judging unit 2302, and a determining unit 2303.

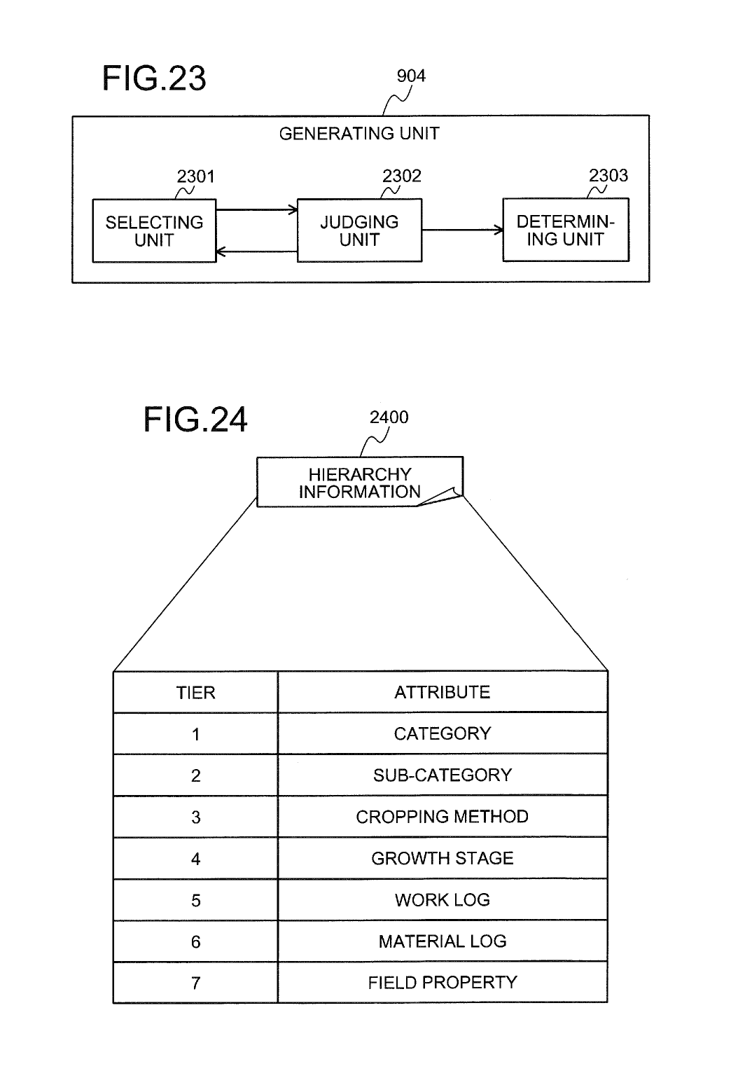

The selecting unit 2301 selects an attribute As from among the attributes A1 to AS characterizing a candidate field F[k]. For example, the selecting unit 2301 may refer to hierarchy information 2400 depicted in FIG. 24 and from among the attributes A1 to AS, which characterize the candidate field F[k] and are hierarchally arranged, sequentially select an attribute As starting from an upper tier. Here, an example of the hierarchy information 2400 will be described.

FIG. 24 is a diagram depicting an example of hierarchy information. In FIG. 24, the hierarchy information 2400 is information indicating the hierarchal structure of attributes that characterize the candidate field F[k]. In the present example, among the attributes, the smaller the tier number of an attribute is, the higher the tier of the attribute is. In other words, the selecting unit 2301 refers to the hierarchy information 2400 and from among the attributes, sequentially selects the attributes in ascending order of tier number (category→sub-category→cropping method→ . . . →field property).

Tiers of the attributes As are set such that attributes that are useful for the user in identifying the field Fj shown in an image Pr are of higher tiers. For example, if attribute values differ among the candidate fields F[1] to F[K], an attribute As affording easy identification of a field Fj shown in an image Pr is set to be of a higher tier. The hierarchy information 2400 is, for example, implemented by a storage device such as the ROM 302, the RAM 303, the magnetic disk 305, and the optical disk 307.

The reference of description returns to FIG. 23. The judging unit 2302 judges whether the attribute values of the selected attribute As coincide among the candidate fields F[1] to F[K]. Here, as one example, the candidate fields F[1] to F[K] are assumed to be “the candidate fields F4 and F5” and the selected attribute As is assumed to be the “category”.

In this case, the category of the candidate field F4 is “irrigated rice” and the category of the candidate field F5 is “irrigated rice” (refer to FIG. 21), and therefore, the judging unit 2302 judges that the categories of the candidate fields F4 and F5 coincide. Further, assuming the selected attribute As is the “growth stage”, the growth stage of the candidate field F4 is the “harvesting phase” and the growth stage of the candidate field F5 is the “growth phase” (refer to FIG. 21) and therefore, the judging unit 2302 judges that the growth stages of the candidate fields F4 and F5 do not coincide.

The determining unit 2303, based on the judgment result, determines an attribute that characterizes the candidate field F[k] and that is to be displayed on the field changing screen (hereinafter, “display attribute”). For example, the determining unit 2303 determines an attribute for which attribute values among the candidate fields F[1] to F[K] have been judged to not coincide. Thus, an attribute for which the attribute values among the candidate fields F[1] to F[K] do not coincide can be determined as a display attribute.

The determining unit 2303, consequent to reiteration of the above coincidence judgment until the attribute values of an attribute As sequentially selected in ascending order of tier number are judged to not coincide among the candidate fields F[1] to F[K], may determine, as display attributes, an attribute for which attribute values coincide among the fields and an attribute for which attribute values do not coincide among the fields.

For example, in the example of the candidate fields F4 and F5 depicted in FIG. 21, for the “category”, which is of tier 1, the attribute values “irrigated rice” are judged to coincide between the candidate fields F4 and F5. For the “sub-category”, which is of tier 2, the attribute values “hitomebore” are judged to coincide between the candidate fields F4 and F5. For the “cropping method”, which is of tier 3, the attribute values “transplanting” are judged to coincide between the candidate fields F4 and F5. For the “growth stage”, which is of tier 4, the attribute values “harvesting phase*growth phase” are judged to not coincide between the candidate fields F4 and F5.

In this case, the determining unit 2303 determines, as display attributes, the attributes “category”, “sub-category” and “cropping method” for which values thereof have been judged to coincide between the candidate fields F4 and F5, and the attribute “growth stage” for which values have been judged to not coincide between the fields. Thus, a given attribute for which attribute values do not coincide among the candidate fields F[1] to F[K] as well as attribute attributes of tiers higher than the given attribute can be determined as display attributes.

An attribute among the attributes A1 to AS characterizing the candidate field F[k] may be preliminarily set as a display attribute. For example, an attribute that at minimum may be needed when the user links the image Pr and a candidate field F[k] may be preliminarily set as a display attribute (e.g., category, sub-category, and cropping method).

The generating unit 904, based on the determination result, generates the field changing screen data Cr for the image Pr. For example, the generating unit 904 extracts the attribute value of the display attribute, from the field data 400-[k] of the candidate field F[k] and by setting the extracted attribute value into the display area 1402 for the template 1400 depicted in FIG. 14, thereby generates the field changing screen data Cr for the image Pr.

Next, a procedure of a display attribute determination process by the work support apparatus 101 according to the third embodiment will be described. The attributes A1 to AS characterizing the candidate field F[k] are sorted in ascending order of tier number. In other words, the attribute A1 is of the highest tier and the attribute AS is of the lowest tier.

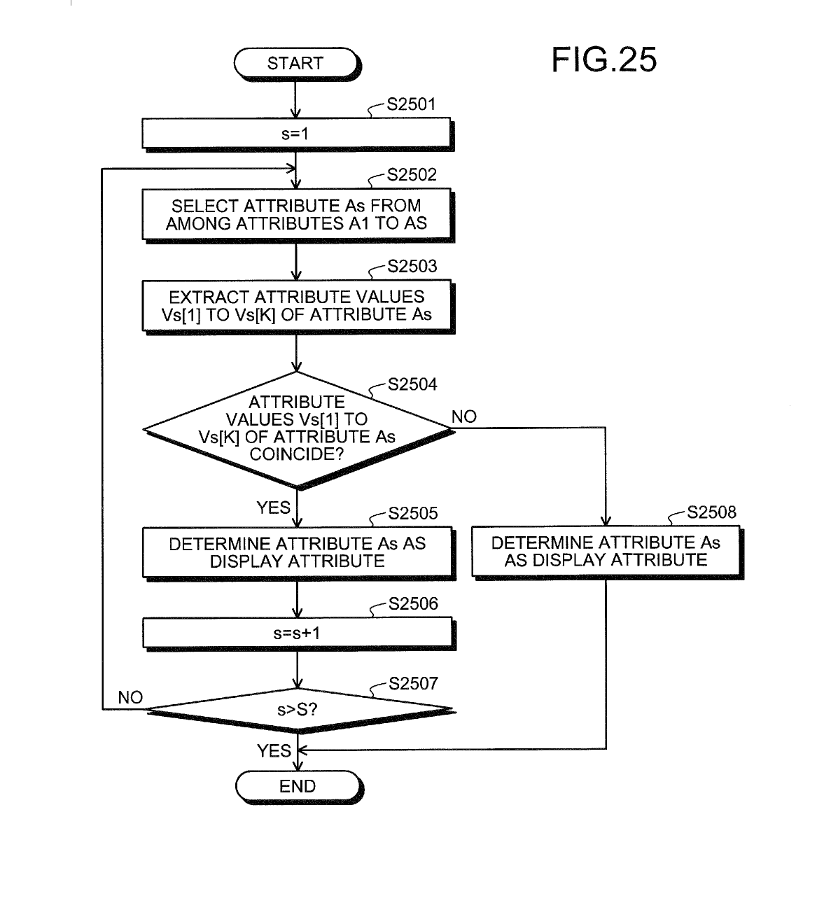

FIG. 25 is a flowchart of a procedure of the display attribute determination process by the work support apparatus 101 according to the third embodiment. In FIG. 25, the selecting unit 2301 sets “s” of the attribute As characterizing the candidate field F[k] to be “s=1” (step S2501). The selecting unit 2301 selects the attribute As from among the attributes A1 to AS characterizing the candidate field F[k] (step S2502).

The judging unit 2302 extracts the attribute values Vs[1] to Vs[K] of the attribute As, from the field data 400-[1] to 400-[K] of the candidate fields F[1] to F[K], in the field DB 110(step S2503). The judging unit 2302 judges whether the attribute values Vs[1] to Vs[K] of the attribute As coincide among the candidate fields F[1] to F[K] (step S2504).

If the attribute values Vs[1] to Vs[K] of the attribute As coincide (step S2504: YES), the determining unit 2303 determines the attribute As as a display attribute (step S2505). The selecting unit 2301 increments “s” of the attribute As (step S2506), and judges whether “s” exceeds “S” (step S2507).

If “s” is less than or equal to “S” (step S2507: NO), the flow returns to step S2502. On the other hand, if “s” exceeds “S” (step S2507: YES), a series of operations according to the flowchart ends.

At step S2504, if the attribute values Vs[1] to Vs[K] of the attribute As do not coincide (step S2504: NO), the determining unit 2303 determines the attribute As as a display attribute (step S2508), ending a series of operations according to the flowchart.

Thus, a given attribute for which attribute values do not coincide among the candidate fields F[1] to F[K] as well as attributes of tiers higher than that of the given can be determined as display attributes.

The display attribute determination process, for example, may be executed after step S1904 depicted in FIG. 19. Further, at step S1910 depicted in FIG. 19, the attribute values of the display attribute determined by the display attribute determination process are extracted. Here, the field changing screen according to the third embodiment will be described.

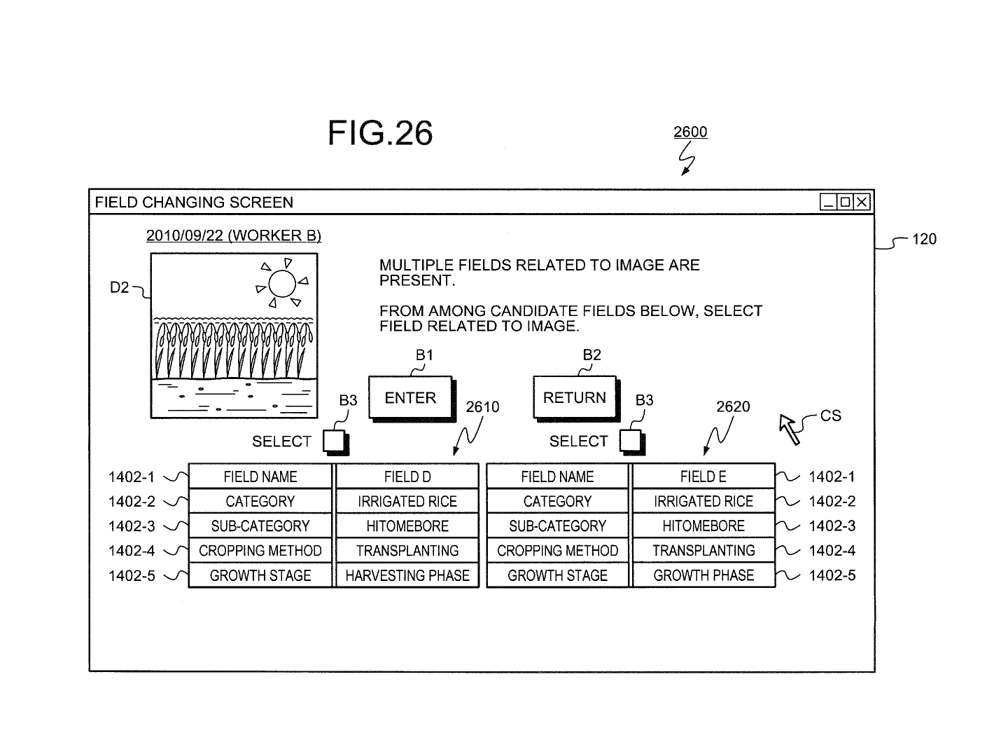

FIG. 26 is a diagram depicting an example of the field changing screen (part 2). In FIG. 26, a field changing screen 2600 displays the image date/photographer of the image P2, the image data D2 of the image P2, and candidate field data 2610 and 2620 of the candidate fields F4 and F5 related to the image P2.

For example, in the display area 1402-1 for the candidate field data 2610, the field name “field D” of the candidate field F4 is set. In the display area 1402-2 for the candidate field data 2610, the category “irrigated rice” of the crop cultivated in the candidate field F4 is set. Further, in the display area 1402-3 for the candidate field data 2610, the sub-category “hitomebore” of the crop cultivated in the candidate field F4 is set.

In the display area 1402-4 for the candidate field data 2610, the cropping method “transplanting” for the crop cultivated in the candidate field F4 is set. Further, in the display area 1402-5 for the candidate field data 2610, the growth stage “harvesting phase” of the crop cultivated in the candidate field F4 is set.

For example, in the display area 1402-1 for the candidate field data 2620, the field name “field E” of the candidate field F5 is set. In the display area 1402-2 for the candidate field data 2620, the category “irrigated rice” of the crop cultivated in the candidate field F5 is set. Further, in the display area 1402-3 for the candidate field data 2620, the sub-category “hitomebore” of the crop cultivated in the candidate field F5 is set.

In the display area 1402-4 for the candidate field data 2620, the cropping method “transplanting” for the crop cultivated in the candidate field F5 is set. Further, in the display area 1402-5 for the candidate field data 2620, the growth stage “growth phase” of the crop cultivated in the candidate field F5 is set.

In other words, on the field changing screen 2600, among attributes characterizing the candidate fields F4 and F5, the attribute values of the attribute “growth stage” for which the attribute values do not coincide between the candidate fields F4 and F5, and the attribute values of the attributes “category, sub-category, cropping method” of tiers higher than that of the attribute “growth stage” are displayed. As a result, compared to the field changing screen 2100 depicted in FIG. 21, the volume of information display on the field changing screen 2600 is less.

On the field changing screen 2600, the attribute values of the attribute “growth stage” for which the attribute values do not coincide between the candidate fields F4 and F5 may be display with emphasis. As a result, an attribute for which the attribute values do not coincide can be easily distinguished and enabling improved convenience for the user.

As described, the work support apparatus 101 according to the third embodiment enables an attribute for which attribute values do not coincide among the candidate fields F[1] to F[K] to be determined as a display attribute. Thus, the attribute values of an attribute for which attribute values do not coincide among the candidate fields F[1] to F[K] alone can be displayed. As a result, for example, the information that at minimum may be needed to identify the field Fj shown a image Pr can be displayed, enabling the volume of information displayed on the field changing screen to be reduced.

The work support apparatus 101 enables a given attribute for which attribute values do not coincide among the candidate fields F[1] to F[K] as well as attributes of tiers higher than that of the given attribute to be determined as display attributes. Thus, as much material as possible is presented for identifying the field Fj shown in an image Pr while the volume of information displayed on the field changing screen is restricted.

Thus, the work support program and work support apparatus according to the embodiment enables the efficiency of the editing performed for linking the image Pr and a field Fj to be improved.

The work support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A work support method executed by a computer, the work support method comprising:
acquiring an image of a field, where position information of a mobile terminal when the mobile terminal recorded the image is appended to the image;
searching among a group of fields and based on position information of each field of the group of fields, for a field that is within a given range of a position indicated by the position information appended to the image; and
correlating with the image and outputting, annunciation information indicating that multiple fields related to the image are present, when multiple fields are retrieved.

2. The work support method according to claim 1, further comprising
extracting from a database storing attribute values of attributes that characterize each field of the group of fields, attribute values of an attribute that characterizes each field retrieved as a candidate field at the searching, wherein
the correlating and outputting includes correlating with the image and outputting, the extracted attribute values of the attribute characterizing each candidate field.

3. The work support method according to claim 2, wherein
the database stores the attribute values of at least any one among the attributes including a category, a sub-category, and a cropping method of crops cultivated in the group of fields, and
the extracting includes extracting from the database, the attribute values of at least any one among the category, the sub-category, and the cropping method of the crop cultivated in each candidate field.

4. The work support method according to claim 3, wherein
the database stores the attribute values of an attribute indicative of a growth stage of the crops cultivated in the group of fields, and
the extracting includes extracting from the database, the attribute values of the attribute indicative of the growth stage of the crop cultivated in each candidate field.

5. The work support method according to claim 4, wherein
the database stores the attribute values of an attribute indicative of a work time and work details concerning farm work performed in the group of fields, and
the extracting includes extracting from the database, the attribute values of the attribute indicative of the work time and the work details concerning the farm work performed in each candidate field just before an image time when the image was recorded.

6. The work support method according to claim 5, wherein
the database stores the attribute values of an attribute indicative of farm equipment used in the farm work performed in the group of fields, and
the extracting includes extracting from the database, the attribute values of the attribute indicative of the farm equipment used in the farm work performed in each candidate field just before the image time when the image was recorded.

7. The work support method according to claim 6, wherein
the database stores the attribute values of an attribute indicative of field properties of the group of fields, and
the extracting includes extracting from the database, the attribute values of the attribute indicative of the field properties of the candidate fields.

8. The work support method according to claim 7, further comprising
selecting from among the extracted attributes characterizing each candidate field, any one attribute; and
judging whether the attribute values of the selected attribute coincide among the candidate fields, wherein
the correlating and outputting includes correlating with the image and outputting, the attribute values of the attribute for which the attribute values are judged to not coincide among the candidate fields.

9. The work support method according to claim 8, wherein
the selecting includes sequentially selecting from among the attributes that characterize the candidate fields and are arranged in hierarchal tiers, an attribute of an upper tier,
the judging includes judging whether the attribute values of the selected attribute coincide among the candidate fields, and
the correlating and outputting includes correlating with the image and outputting, the attribute values of each attribute for which the attribute values are judged to coincide among the candidate fields and the attribute values of an attribute for which the attribute values are judged to not coincide among the candidate fields, as a result of reiteration of the selecting and the judging.

10. The work support method according to claim 9, further comprising
calculating for each side of a polygon representing on a map, a field of the group of fields that are dispersed, a distance between the side and a coordinate point that is on the map and indicated by the position information of the mobile terminal, wherein
the searching includes searching among the group of fields, for a field for which a shortest distance among the calculated distances is less than or equal to a threshold.

11. The work support method according to claim 1, further comprising
correcting the position information that is appended to the image and for the mobile terminal, based on a set of position information of the mobile terminal acquired during a given interval that includes an image time when the image was recorded, wherein
the searching includes searching the group of fields, for a field that is within a given range of a position indicated by the position information of the mobile terminal after correction at the correcting.

12. The work support method according to claim 11, wherein
the searching includes searching the group of fields based on the position information of each field of the group of fields, for a field that includes the position indicated by the position information of the mobile terminal, and when no field is retrieved, includes searching the group of fields, for a field that is within the given range of the position indicated by the position information of the mobile terminal.

13. A non-transitory computer-readable recording medium storing a work support program that causes a computer to execute a process comprising:
acquiring an image of a field, where position information of a mobile terminal when the mobile terminal recorded the image is appended to the image;
searching among a group of fields and based on position information of each field of the group of fields, for a field that is within a given range of a position indicated by the position information appended to the image; and
correlating with the image and outputting, annunciation information indicating that multiple fields related to the image are present, when multiple fields are retrieved.

14. A work support apparatus comprising
a computer that is configured to:
acquire an image of a field, where position information of a mobile terminal when the mobile terminal recorded the image is appended to the image;
search among a group of fields and based on position information of each field of the group of fields, for a field that is within a given range of a position indicated by the position information appended to the image; and
correlate with the image and output, annunciation information indicating that multiple fields related to the image are present, when multiple fields are retrieved.
